(19) United States
(12) Patent Application Publication
(10) Pub. No.: US 2026/0347128 A1
(43) Pub. Date: Nov. 5, 2026

(54) SEALS FOR DOCK LEVELERS

(71) Applicant: Rite-Hite Holding Corporation, Milwaukee, WI (US)

(72) Inventors: Jared Lueken, Dyersville, IA (US); Frank Heim, Platteville, WI (US); Gary Borgerding, Dubuque, IA (US); Austyn Hayes, Dubuque, IA (US)

(21) Appl. No.: 19/488,535

(22) PCT Filed: May 31, 2024
(86) PCT No.: PCT/US2024/032040

§ 371 Date: Nov. 26, 2025

Related U.S. Application Data
(60) Provisional application No. 63/505,622, filed on Jun. 1, 2023.

(51) Int. Cl. B65G 69/00; F16J 15/02

(52) U.S. Cl. CPC B65G 69/008; F16J 15/022

(57) ABSTRACT

Example seals for loading docks are disclosed. An example seal assembly includes a rear seal including a plurality of posts, a front seal, and a plurality of stays. The stays pivotally couple the front seal and the posts.

### CROSS-REFERENCE TO RELATED APPLICATIONS

This patent claims the benefit of U.S. Provisional Patent Application No. 63/505,622, which was filed on Jun. 1, 2023. U.S. Provisional Patent Application No. 63/505,622 is hereby incorporated herein by reference in its entirety. Priority to U.S. Provisional Patent Application No. 63/505,622 is hereby claimed.

### FIELD OF THE DISCLOSURE

This disclosure relates generally to dock levelers and, more particularly, to seals for dock levelers.

### BACKGROUND

A loading dock of a building includes an exterior doorway with an elevated loading dock platform for loading and/or unloading vehicles, such as trucks and trailers positioned adjacent the doorway. To compensate for a height difference between the loading dock platform and an adjacent cargo bed of a vehicle (e.g., a truck or a trailer), many loading docks have a dock leveler. Dock levelers include a deck or ramp pivotally hinged along a back edge to vary a height of a front edge relative to the cargo bed of the vehicle. To span a gap between the front edge of the deck and a rear of the vehicle's cargo bed, the dock leveler includes an extension plate or lip that extends outward from the front edge of the deck.

### BRIEF DESCRIPTION OF THE DRAWINGS

FIG. 1A is a front view of an example loading dock with an example vehicle shown in phantom lines.

FIG. 1B is a perspective view of the loading dock of FIG. 1A from a viewpoint of an interior of the example loading dock toward a rear end of the example vehicle of FIG. 1A.

FIG. 1C is another perspective view of the example loading dock of FIGS. 1A and 1B.

FIG. 2 is a front view of an example loading dock implemented with an example seal apparatus constructed in accordance with teachings of this disclosure.

FIG. 3 is a cross-sectional side view of the example loading dock of FIG. 2 with an example dock leveler in an example stored position.

FIG. 4 is a perspective view of the example loading dock of FIG. 2 with the example dock leveler in an example partially stored position.

FIG. 5 is similar to FIG. 4 except that portions of the example seal apparatus are shown in phantom.

FIG. 6 is an exploded view of an example rear seal assembly of the example seal apparatus of FIGS. 2-5.

FIG. 7 is a perspective view of the example rear seal assembly of the example seal apparatus of FIGS. 2-6.

FIG. 8A is a perspective view of an example support post of the seal apparatus of FIGS. 2-7.

FIG. 8B is a perspective, front view of an example mounting bracket of the example support post of FIG. 8A.

FIG. 8C is a perspective, rear view of the example mounting bracket of FIG. 8B.

FIG. 9 is a cross-sectional side view of an example core of the example seal apparatus of FIGS. 2-7 and 8A-8C.

FIG. 10 is a cross-sectional side view of another example core that can implement the example support post of FIG. 9.

FIGS. 11A-11B are cross-sectional side views of other example cores that can implement the example support post of FIG. 9.

FIG. 12 is another perspective view of the example loading dock and the example seal apparatus of FIGS. 2-9.

FIG. 13 is a top view of the example loading dock of FIGS. 1-7 and 12.

FIG. 14A is a cross-sectional side view of an example front seal of the seal apparatus of FIGS. 2-9 and 12-13.

FIG. 14B is a cross-sectional front view of the example front seal of the example seal apparatus of FIGS. 2-9 and 12-13.

FIG. 14C is a cross-sectional front view of another example front seal that can implement the example seal apparatus of FIGS. 2-9 and 12-13.

FIG. 15A is a perspective, side view of an example flexible mount of the example seal apparatus of FIGS. 2-9 and 12-13.

FIG. 15B is a perspective, front view of the example flexible mount of FIG. 15A.

FIG. 16A a perspective view of a portion of the example flexible mount of FIGS. 15A and 15B.

FIG. 16B is a perspective view of the portion of the example flexible mount of FIG. 16A but with an example spring of the example flexible mount shown in a semi-transparent state.

FIG. 17A is a perspective view of the example flexible mount of FIGS. 15A and 15B shown in an example non-deflected position.

FIG. 17B is a perspective view of the example flexible mount of FIGS. 15A and 15B in an example forward deflected position.

FIG. 17C is a perspective view of the example flexible mount of FIGS. 15A and 15B in an example rearward deflected position.

FIG. 18 is a cross-sectional side view of the example loading dock of FIGS. 2-9 and 12-13 with the example dock leveler in an example standard loading position.

FIG. 19 is a cross-sectional side view of the example loading dock of FIGS. 2-9 and 12-13 with the example dock leveler in an example cross-traffic position.

FIG. 20 is a cross-sectional side view of the example loading dock of FIGS. 2-9 and 12-13 with the example dock leveler in an example below-dock position.

FIG. 21 is a cross-sectional side view of the example loading dock of FIGS. 18-20 with the example dock leveler in an example intermediate position.

FIG. 22 is a cross-sectional side view of the example loading dock of FIGS. 18-20 with the example dock leveler in the example cross-traffic position of FIG. 19.

FIG. 23 is a perspective view of another example rear seal that can implement an example seal apparatus disclosed herein.

FIG. 24 is a perspective view of another example rear seal that can implement an example seal apparatus disclosed herein.

FIGS. 25-27 are perspective, partially assembled views of the example rear seal of FIG. 24.

FIG. 28 is an exploded view of another example rear seal that can implement the example seal apparatus of FIGS. 2-5.

FIG. 29 is a side view of the example rear seal of FIG. 28.

FIG. 30 is a perspective, bottom view of an example first support post of the rear seal of FIGS. 28 and 29.

FIG. 31 is another perspective, bottom view of the example first support post of FIGS. 28-30.

FIG. 32 is a perspective view of an example mounting bracket of the rear seal of FIGS. 28 and 29.

FIG. 33A is a perspective view of another example seal assembly disclosed herein.

FIG. 33B is an exploded view of the example seal assembly of FIG. 33A.

FIG. 34 is an exploded perspective rear view of an example first seal of the seal assembly of FIG. 33A.

FIG. 35 is an exploded perspective front view of an example second seal of the seal assembly of FIG. 33A.

FIG. 36 is a perspective view of the example loading dock of FIG. 1 implemented with the example seal assembly of FIG. 33A.

FIG. 37 is another perspective view of the example loading dock of FIG. 36.

FIG. 38A is an enlarged, partial perspective view of the example loading dock of FIG. 36.

FIG. 38B is a top view of the example loading dock of FIG. 36.

FIG. 39A is a front view of the example loading dock of FIG. 36 with the example seal assembly in a partially assembled state.

FIG. 39B is an enlarged, partial view of FIG. 39A.

FIG. 40 is a side view of the example loading dock of FIG. 36 with the example seal assembly in an example initial position.

FIG. 41A is a side view of the example loading dock of FIG. 36 with the example seal assembly in an example first deflected position.

FIG. 41B is a partial side view of the example loading dock of FIG. 36 with the example seal assembly in an example second deflected position.

FIG. 42 is a partial side view of the example loading dock of FIG. 36 with the example seal assembly in an example third deflected position.

Certain examples are shown in the above-identified figures and described in detail below. In general, the same reference numbers will be used throughout the drawing(s) and accompanying written description to refer to the same or like parts. The figures are not necessarily to scale and certain features and certain views of the figures can be shown exaggerated in scale or in schematic for clarity and/or conciseness. Additionally, several examples have been described throughout this specification. Any features from any example can be included with, a replacement for, or otherwise combined with other features from other examples.

### DETAILED DESCRIPTION

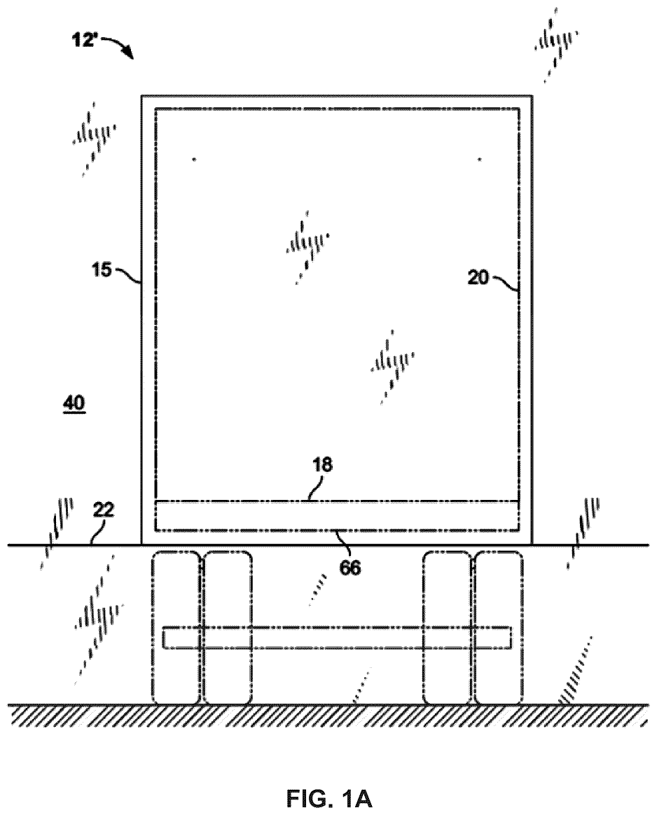

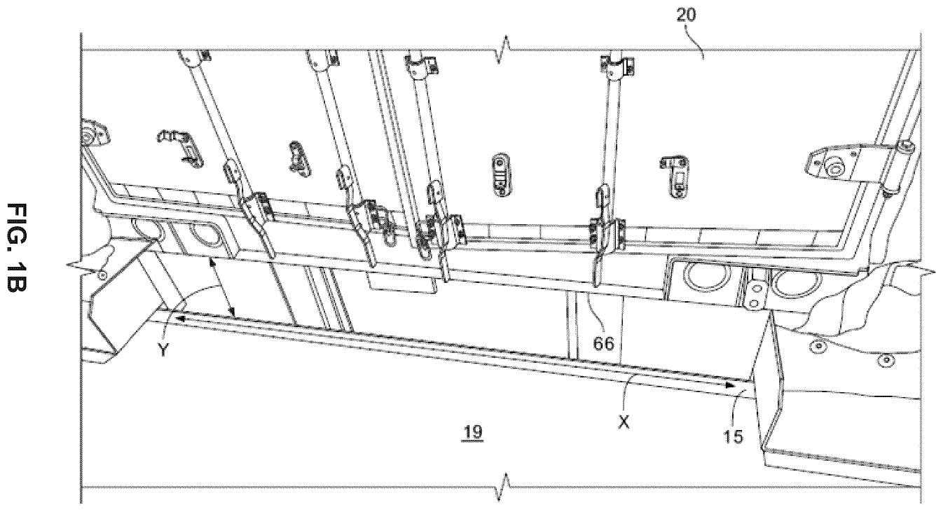

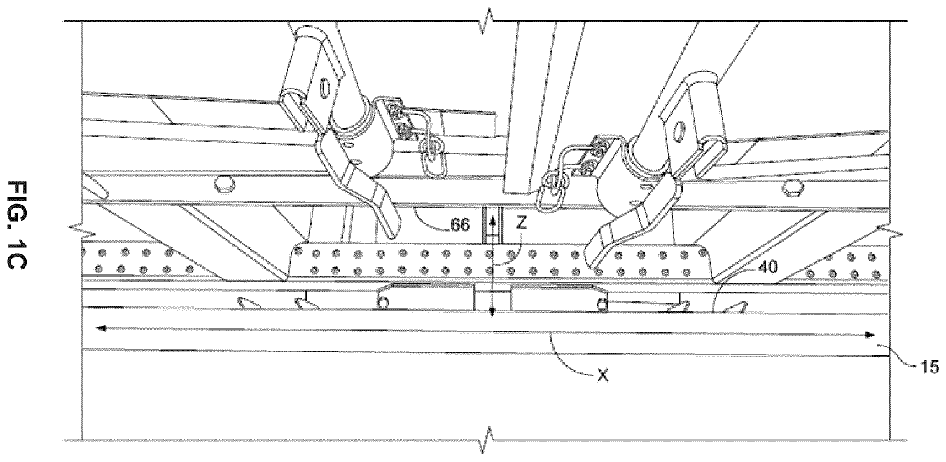

FIG. 1A is a front view of a loading dock 12′. FIG. 1B is a perspective view of the loading dock 12′ of FIG. 1A showing a rear of a vehicle 20 positioned at the loading dock 12′. FIG. 1C is another perspective view of the loading dock 12′ of FIG. 1A showing the rear of the vehicle 20. Referring to FIGS. 1A-1C, the loading dock 12′ of the illustrated example includes a dock leveler to bridge a gap between a platform 22 of the loading dock 12′ and a vehicle cargo bed 18 of the vehicle 20. When the vehicle 20 is positioned adjacent a doorway 15 of the loading dock 12′, a first gap Y (e.g., a gap in an x-y plane in the orientation of FIG. 1B) forms along a width of an opening of the doorway 15 (e.g., in an x-direction) and between a pit floor 19 of the loading dock 12′ and a bottom surface of the rear edge 66 of the vehicle 20 (e.g., in a y-direction). Additionally, a second gap Z (e.g., in an x-z plane in the orientation of FIG. 1C) forms along the width of the opening of the doorway 15 (e.g., in the x-direction) and between a dock face 40 and the rear edge 66 of the trailer (e.g., in a z-direction). In some instances, a third gap forms at a hinge gap between a deck and a lip of a dock leveler. During loading and/or unloading operations, unwanted environmental elements (e.g., cold air, debris, etc.) can pass through the first gap Y, the second gap Z, and/or the third gap.

The dock leveler of FIGS. 1A-1C is a vertical style leveler. In a vertical style leveler, the pit floor 19 can form a continuous area (e.g., without separating walls or structures) between the loading bay 12a and a plurality of adjacent loading bays (e.g., adjacent the loading bay 12a) of the loading dock 12. For example, the pit floor 19 can extend or connect to a pit of an adjacent loading dock bay. A continuous area formed by a plurality of pits facilitates cleaning operations of the pits (e.g., for sanitary applications). For example, when the dock leveler is in a stored position (e.g., a vertical position), the pit floor is generally open and readily accessible for cleaning.

Example seal apparatus disclosed herein seal (e.g., close or reduce) one or more airgaps at a loading dock (e.g., an airgap in the x-y-z direction noted above). For instance, seal apparatus disclosed herein can seal an airgap (e.g., a first airgap) formed between a rear edge of the vehicle and a dock face of a loading dock when a vehicle is parked at the loading dock (e.g., in the x-z direction) and/or an airgap (e.g., a second airgap) between a pit floor of the loading dock and a bottom surface of the rear edge of the vehicle along a width of an opening of the doorway (e.g., in an x-direction). Additionally, some example seal apparatus disclosed herein can seal an airgap (e.g., a third airgap) formed between an outer surface of a lip of a leveler and the vehicle (e.g., when the lip is in a stored position or an end-loading configuration), and/or an airgap (e.g., a fourth airgap) formed between a hinge pivotally coupling the lip and the deck. For example, seals disclosed herein can seal the first gap Y and/or the second gap Z of FIGS. 1B and 1C. Therefore, example seal apparatus disclosed herein prevent or restrict environmental elements (e.g., snow, cold air, debris accumulation, etc.) from entering an interior of a building during a loading and/or unloading operation and/or a pit area of a dock leveler to maintain the pit area relatively clear of obstructions for sanitary and operational purposes.

Further, example seal apparatus disclosed herein do not interfere with an operation of a dock leveler or other dock equipment and/or do not interfere with a cleaning operation of a pit area. In some examples, seal apparatus disclosed herein enable resilient movement and/or compressibility to withstand impact and friction during loading and/or unloading operations. In some examples, seal apparatus disclosed herein employ a single seal (e.g., a front seal or a rear seal) to provide a seal. In some examples, seal apparatus disclosed herein employ a plurality of seals (e.g., a front seal and a rear seal) to provide a seal.

Some example seal apparatus disclosed herein employ a rear seal including a plurality of support posts. Example support posts disclosed herein can be spaced apart along a width of the loading dock (e.g., in a direction along the x-direction). Some example seal apparatus disclosed herein employ a curtain or seal coupled to or otherwise supported by the support posts. In some examples, rear seal apparatus disclosed herein employ rear bulb seals. Example rear bulb seals disclosed herein include a plurality of bulb seals spaced along a width or lateral edges of a doorway. Some example rear seal apparatus disclosed herein employ a single, continuous rear bulb seal that spans between lateral edges of a doorway of a loading dock.

Additionally, example rear seal apparatus (e.g., example support posts or bulb seals) disclosed herein couple to the loading dock via an example tool-free fastener (e.g., mounting brackets). In some examples, a tool-free fastener connects a rear seal of example seal apparatus disclosed herein to a dock face or to some other substantially stationary surface of dock or dock leveler. The term, “tool-free fastener” refers to any connector that can be readily disconnected and reconnected manually without the need for tools. Some examples of tool-free fastener include snaps, VELCRO (registered trademark of Velcro Companies, of United Kingdom), hook-and-loop fasteners, magnets, mounting brackets and/or a combination thereof. In some examples, tool-free fastener includes a series of disc magnets attached to a strip of material extending from an example rear seal. Being able to readily remove and reattach example rear seals disclosed herein without the use of tools makes it easier to access and clean pit.

In some examples, each post or bulb seal includes a dedicated mounting bracket. In some examples, each post or bulb seal includes a plurality of mounting brackets. In some examples, each mounting bracket supports a plurality of posts. In some examples, a bulb seal includes a plurality of mounting brackets. Example mounting brackets disclosed herein can couple to a loading dock via one or more magnets. Thus, example rear seal apparatus disclosed herein can couple to a loading dock without use of fasteners (e.g., such as, anchors, screws, rivets, and/or any other fasteners) that anchor to or penetrate a wall of the loading dock. Additionally, an example curtain of an example rear seal apparatus disclosed herein can be coupled to the example support posts (or bulb seal(s)) and/or the mounting brackets via one or more hook-and-loop fasteners.

Example front seal apparatus disclosed herein are suspended to an example loading dock. Some example front seal apparatus disclosed herein couple to an example loading dock via a cable. In such examples, a first end of a cable anchors to a first end or side of a loading dock via a first bracket and a second end of the cable anchors to a second end or side of the loading dock opposite the first side. Example first and second mounting brackets disclosed herein include a mounting flange for mounting the brackets to the loading dock and a biasing element (e.g., a spring) that enables the ends of the cable to move (e.g., in various directions) relative to the rear seal apparatus. For instance, example front seal apparatus disclosed herein can move in a direction toward the rear seal, a direction away from the rear seal, a direction toward a pit floor or a ground surface, a direction away from the pit floor or a ground surface, and/or any combination thereof. Thus, in some examples, the mounting brackets cause the front seal apparatus to bias toward the rear seal apparatus. Furthermore, the front seal can move forward (e.g., away from the rear seal) when the dock leveler lowers into a loading position and wedges an example lip between the front and rear seals. Thus, when the dock leveler and the lip are in a lowered position, the example mounting brackets can cause sealed contact between the front seal apparatus, the lip, and/or the rear seal apparatus.

Some example front seals disclosed herein are pivotally coupled to the rear seal and/or the loading dock. Some example front seals disclosed herein are pivotally coupled to the rear seals via one or more stays, leaf springs or other biasing elements. Some example front seals can be pivotally coupled to the loading dock via a hinge, a spring-loaded hinge, and/or any other suitable connection to enable pivotal movement of the front seal relative to a rear seal.

Some example seal apparatus disclosed herein includes a first seal portion to seal a gap in the x-y direction and a second seal portion to seal a gap in the x-z direction of FIGS. 1A and 1B. In some examples, the first seal portion is fixed to the pit floor of a loading dock and the second seal portion is movably coupled relative to the first seal portion. In some examples, the second seal portion protrudes or projects in a direction away from a dock face or the first seal portion when the seal apparatus is coupled to a loading dock. In some examples, the first seal portion and the second seal portion can be foam.

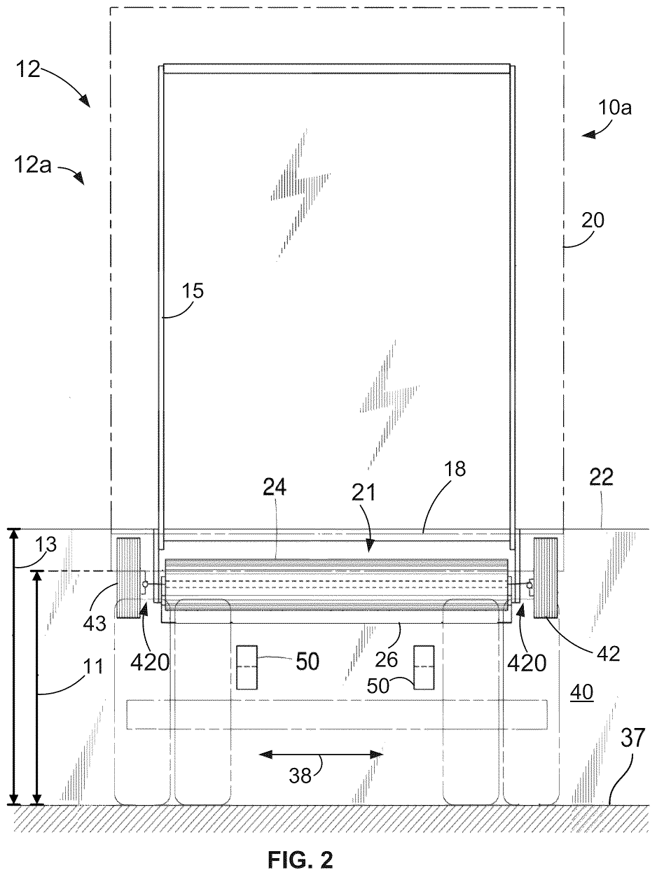

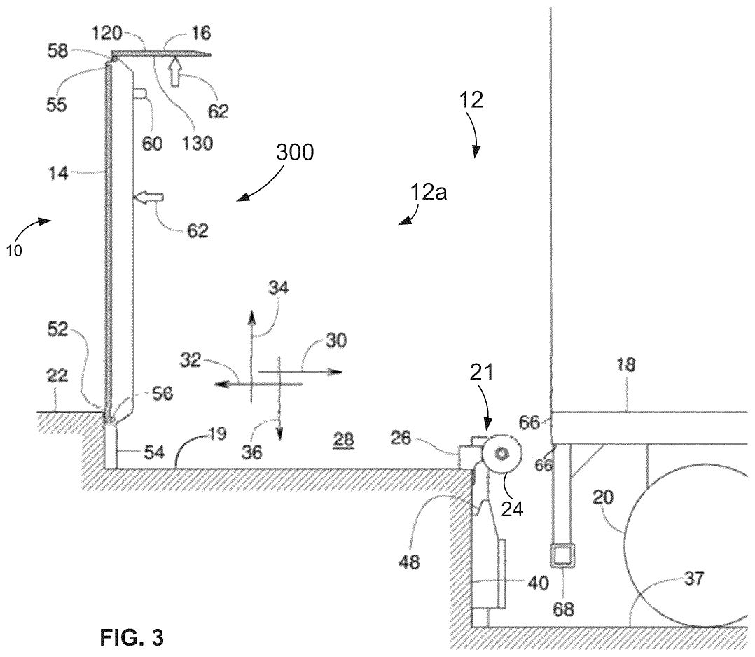

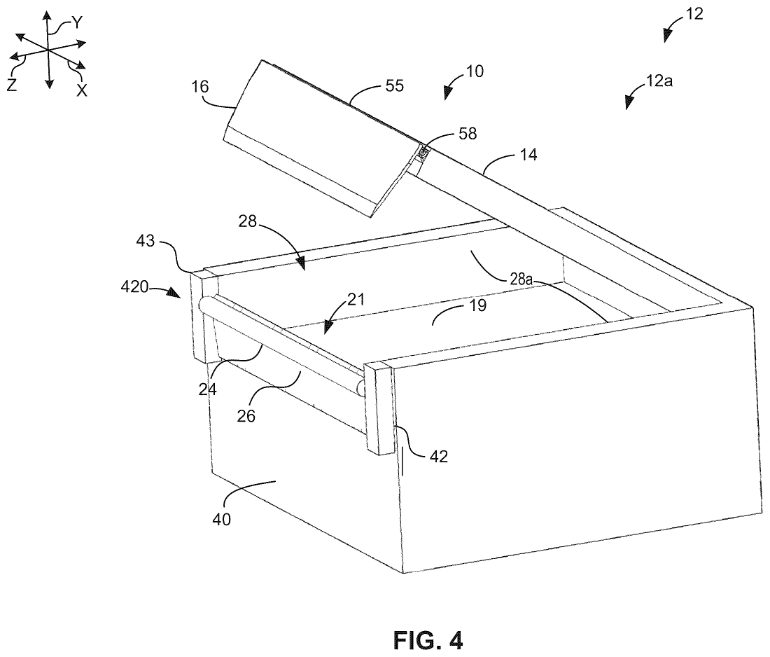

FIG. 2 is a front view of an example loading dock 12 implemented with an example seal assembly 21 (e.g., a seal, a seal apparatus) constructed in accordance with teachings of this disclosure. FIG. 3 is a side view of the example loading dock 12 of FIG. 2 in an example non-traffic or stored position 300. FIG. 4 is a perspective, partial view of the loading dock 12 of FIG. 2 in an example partially stored position (e.g., another non-traffic position).

FIGS. 2-4 illustrate a loading bay 12a of the loading dock 12. In some examples, the loading dock 12 can include a plurality of loading bays positioned adjacent the loading bay 12a. As illustrated in example FIG. 3, for spatial reference, arrow 30 represents a forward direction, arrow 32 represents a rearward direction, arrow 34 represents an upward direction, and arrow 36 represents a downward direction. In FIG. 2, arrow 38 represents a lateral or horizontal direction that is perpendicular to the forward direction 30 and the upward direction 34. The forward direction 30 and the rearward direction 32 are in the z-direction, the upward direction 34 and the downward direction 36 are in the y-direction, and the horizontal or lateral direction 38 is in the x-direction.

Referring to FIGS. 2-4, the loading dock 12 of the illustrated example includes the loading bay 12a having a dock face 40 (e.g., a building wall) defining a doorway 15 (e.g., facing in the forward direction 30) and a driveway 37 to enable the vehicle 20 to access the doorway 15 of the loading dock 12. In some examples, the dock face 40 of the illustrated example includes bumpers 42, 43 to absorb an impact between the vehicle 20 and the dock face 40. In some examples, the loading dock 12 includes other equipment including a vehicle restraint (e.g., a wheel chock, a rear impact guard barrier, a hook, etc.) to inhibit the vehicle 20 from prematurely departing the loading dock 12. In the illustrated example of FIG. 2, the vehicle 20 and other associated elements are illustrated in phantom to establish a vantage point of the front view as being within the example loading bay 12a and facing out of the doorway 15 toward the vehicle 20, the driveway 37, the seal apparatus 21, etc.

To transfer cargo between a platform 22 (e.g., an interior of a building) and a vehicle cargo bed 18 of the vehicle 20, the loading dock 12 of the illustrated examples includes the dock leveler 10. In the illustrated example of FIG. 3, the dock leveler 10 is an upright-stored (e.g., a vertically-stored) leveler. For example, a deck 14 of the dock leveler 10 is in a generally vertical position (e.g., in an x-y plane) when the dock leveler 10 is in the example stored position 300 of FIG. 3. The dock leveler 10 includes the deck 14 and a lip 16 that together provide an articulated adjustable ramp or bridge to transfer goods between the vehicle cargo bed 18 of the vehicle 20 (e.g., truck, trailer, etc.) and a platform 22 of the loading dock 12. The platform 22 of the illustrated example of FIG. 2 is at an elevation 11 from the driveway 37 that is lower than an elevation 13 between a rear edge 66 of the vehicle 20 and the driveway 37. As used herein, the rear edge 66 of the vehicle 20 includes a lower most edge of a trailer (e.g., defining the vehicle cargo bed 18) of the vehicle 20. For example, the lower most edge can include a portion of a surface of the rear edge 66 of the trailer or the vehicle 20 that is oriented toward the dock face 40 and/or a portion of a surface of the rear edge 66 of the trailer or vehicle 20 that is oriented toward the driveway 37. In some examples, the seal assembly 21 disclosed herein engages or seals against at least a portion of the surface(s) of the vehicle 20 defined by the rear edge 66 that is oriented toward the dock face 40 and/or the surface of the vehicle 20 defined by the rear edge 66 that is oriented toward the driveway 37.

The dock leveler 10 of the illustrated examples is a pit-style leveler configuration. In a pit-style leveler configuration, a pit 28 is formed in the platform 22 such that a pit floor 19 is recessed relative to the platform 22 to provide an area (e.g., a void) to enable the deck 14 to pivot between a fully raised position (e.g., the example stored position 300 of FIG. 3) and various lower or operational positions (e.g., a cross-traffic position, a below-dock cross-traffic position, etc.) relative to the vehicle 20 (e.g., the vehicle cargo bed 18) for loading and/or unloading operations. In some instances, a dock leveler of a pit-style leveler can be a horizontally-stored leveler. For example, a deck can be generally in a horizontal position (e.g., an x-z plane) when the deck is in a stored position. In contrast to vertically-stored levelers (e.g., the vertically-stored leveler of FIGS. 1A-1C), the pit 28 of the pit-style leveler configuration is not continuous relative to adjacent loading dock bays. In other words, the platform 22 is positioned on either side of a pit and does not extend or connect to a pit of an adjacent loading dock bay. For example, the pit 28 includes lateral side walls 28a partially surrounding the pit floor 19. However, in some examples, the example seal assembly 21 can be implemented with other types of loading docks and/or dock levelers such as, for example, a vertical-style leveler. For example, the seal assembly 21 can be implemented with the loading dock 12′ and/or the dock leveler of FIGS. 1A-1C.

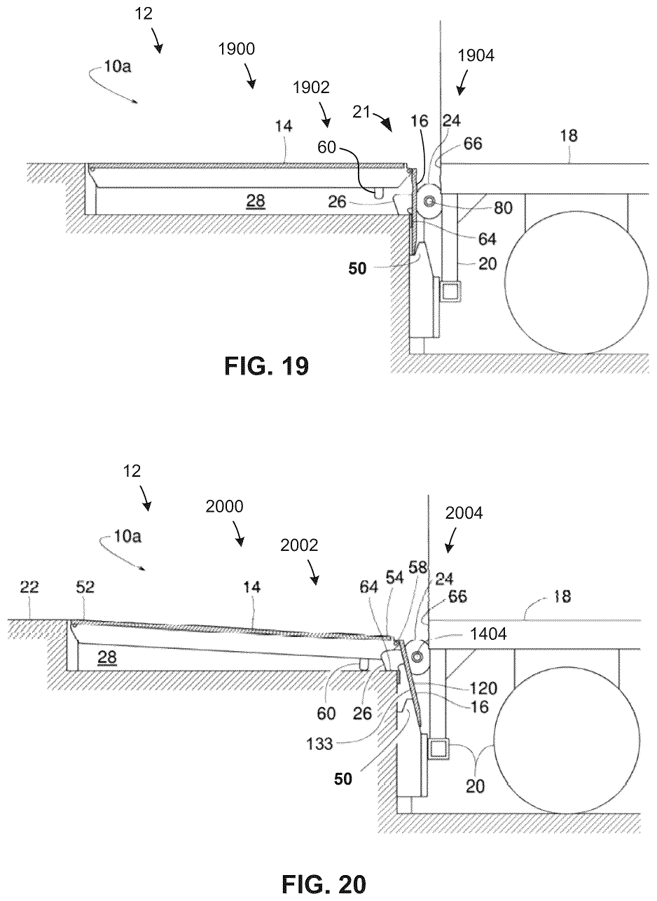

In FIG. 3, the dock leveler 10 is in the example stored position 300. In the stored position 300, the deck 14 is at a raised position (e.g., a fully raised position) and the lip 16 is at a retracted position (e.g., a fully retracted position or pendant). Referring to FIG. 3, to enable the deck 14 to pivot relative to the platform 22, the dock leveler 10 is pivotally coupled to a frame 54 that is positioned (e.g., anchored) in the pit 28. To pivotally couple the deck 14 to the frame 54, a rear edge 52 of deck 14 is coupled to the frame 54 via a rear hinge 56. To pivotally couple the lip 16 and the deck 14, the lip 16 is coupled to a front edge 55 of the deck 14 via a front hinge 58. The front hinge 58 at the front edge 55 of the deck 14 and the rear hinge 56 at the rear edge 52 of the deck 14 enable the dock leveler 10 to adjust or compensate for a height differential between the platform 22 and the vehicle cargo bed 18. To receive and/or support the lip 16 when the lip 16 is in a cross-traffic position (e.g., a cross-traffic position 1900 of FIG. 19), the loading dock 12 of the illustrated example includes one or more lip keepers 50.

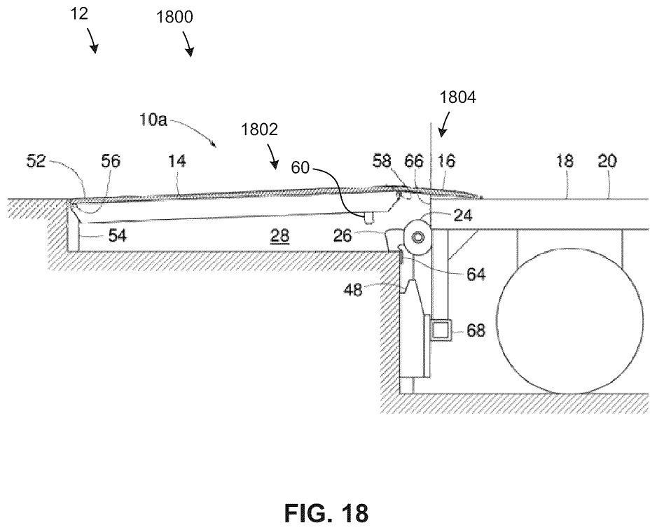

To move the deck 14 and/or the lip 16 between the stored position 300 of FIG. 3 and various lowered positions (e.g., example positions of FIGS. 18-20), the dock leveler 10 employs components including, but not limited to, one or more actuators (e.g., hydraulic cylinders, linear motors, mechanical linkages, inflatable bladders, springs, and combinations thereof, etc.) that can apply actuating forces (e.g., tensile forces, compressive forces, etc.) on areas represented by arrows 62 shown in FIG. 3. These components, such as the actuators, can be stored underneath the dock leveler 10. The dock leveler 10 includes a plurality of stump out legs 60 coupled to an underside of the deck 14 to restrict or limit a lowermost position of the dock leveler 10 to protect the components (e.g., hydraulic components) from damage. For example, as the deck 14 lowers past a substantially parallel position relative to the platform 22, the stump out legs 60 can contact (e.g., brace against) the pit floor 19 to impede further rotational movement of the deck 14 via the rear hinge 56 and define a lowermost, cross-traffic position of the dock leveler 10. The stump out legs 60 are spaced apart along a width of the deck 14 (e.g., in the lateral direction 38 of FIG. 2, an x-direction of FIG. 4, etc.).

To seal one or more gaps (e.g., the first gap Y of FIG. 1B, the second gap Z of FIG. 1C, etc.) that may otherwise form between the loading dock 12 (e.g., the lip 16) and the vehicle 20 and/or the dock face 40 and the vehicle 20 (e.g., due to a height variation between the platform 22 and the vehicle cargo bed 18), the loading dock 12 of the illustrated example includes the seal apparatus 21. The seal assembly 21 couples to the pit 28 and/or the loading dock 12. Specifically, the seal assembly 21 spans a distance or width of the dock leveler 10 (e.g., in the x-direction) and/or between lateral side edges (e.g., vertical side walls) of the doorway 15, the height between the pit floor 19 and the rear edge 66 of the vehicle 20, and the distance or length between the dock face and the rear edge 66 of the vehicle 20.

The seal assembly 21 of the illustrated example seals against or engages the rear edge 66 of the vehicle 20 when the vehicle 20 is parked at the loading dock 12. For example, the seal assembly 21 of the illustrated example includes a first or front seal 24 and a second or rear seal 26. In some examples, the front seal 24 and/or the rear seal 26 engage the rear edge 66 of the vehicle 20 such that at least a portion of the front seal 24 and/or the rear seal 26 engage at least a portion of a surface of the vehicle 20 adjacent the rear edge 66 that is oriented toward the dock face 40 and/or a portion of a surface of the vehicle 20 adjacent the rear edge 66 that is oriented toward the driveway 37.

As described below, the seal assembly 21 (e.g., the rear seal 26) of the illustrated example does not interfere with the stump out legs 60 of the deck 14 during operation. Additionally, the rear seal 26 of the illustrated example is coupled to the pit 28 and/or the loading dock 12 via one or more tool-free fasteners. In some examples, a tool-free fastener connects the rear seal 26 to dock face 40, the pit floor 19, or to some other mounting surface (e.g., a substantially stationary surface) of the loading dock 12, the pit 28, and/or dock leveler 10. Some examples of mounting surfaces include the dock face 40 and the frame 54 of the dock leveler 10. The term, “tool-free fastener” refers to any connector that can be readily disconnected and reconnected manually without the need for tools. Example tool-free fasteners are described in detail below. Further, the front seal 24 of the illustrated example is coupled to loading dock via a mounting system 420. As illustrated in the example of FIG. 4 and described in greater detail below, the mounting system 420 enables the front seal 24 of the illustrated example to move relative to the rear seal 26. For example, the mounting system 420 enables the front seal 24 to move in the forward direction 30, the rearward direction 32, the upward direction 34, the downward direction 36, the lateral direction 38, and/or a combination thereof.

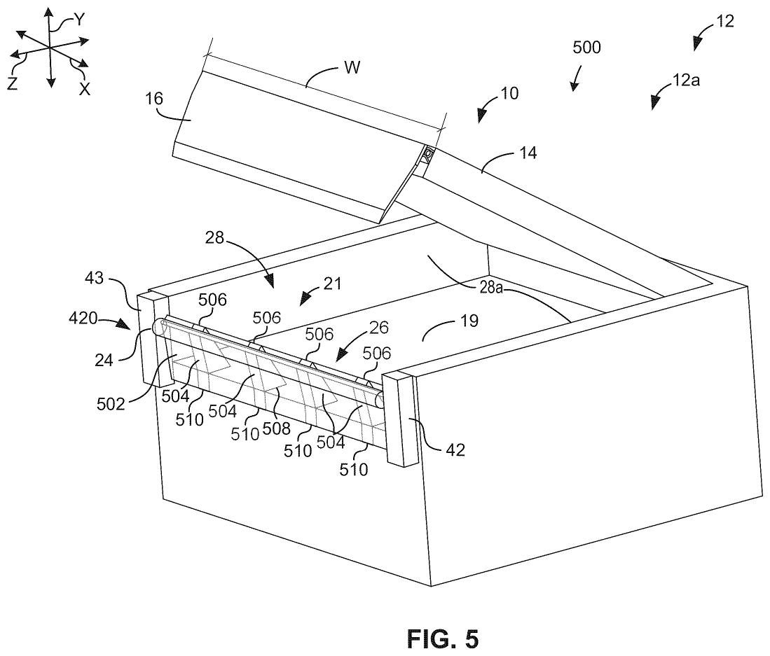

FIG. 5 is a perspective view of the loading dock 12 of FIG. 2 with the dock leveler 10 in the example partially stored position and with a portion of the example seal assembly 21 shown in phantom. The rear seal 26 of the illustrated example (e.g., a rear seal assembly) includes a shield or curtain 502 (shown in phantom) and a plurality of support posts 504 (e.g., support pillars). The support posts 504 are spaced apart along a width W of the dock leveler 10 (e.g., in the x-direction) and/or between the lateral side walls of the pit 28. The support posts 504 of the illustrated example can be spaced apart at equal distances or at any desired distance. Each of the support posts 504 of the illustrated example is coupled to the pit 28 via a fastener 510 (e.g., a tool-free fastener). In some examples, the fastener 510 is a resealable fastener that can be coupled and/or decoupled from the loading dock 12 by hand without the need for tools or apparatus. Thus, the fastener 510 enables the support posts 504 to be positioned at any desired position to facilitate installation and/or enable quick removal of the rear seal 26 (e.g., without use of tools) to enable access to the pit floor 19 (e.g., during cleaning operation, maintenance, etc.). Additionally, the support posts 504 can be positioned away from the stump out legs 60. In other words, the support posts 504 can be positioned along the x-direction such that a respective one of the stump out legs 60 can be positioned in a space defined between respective two adjacent ones of the support posts 504. In some examples, the support posts 504 and the stump out legs 60 define an alternating pattern. In this manner, the support posts 504 do not interfere with the stump out legs 60 during operation of the dock leveler 10.

The curtain 502 is coupled to the support posts 504. Specifically, the support posts 504 of the illustrated example support the curtain 502. The curtain 502 of the illustrated example hangs or suspends from adjacent respective upper edges 506 (e.g., uppermost edges) of the support posts 504 and extends below respective lower edges 508 (e.g., lowermost edges) of the support posts 504. The curtain 502 extends between the first bumper 42 (e.g., a right-side bumper) and the second bumper 43 (e.g., a left-side bumper). In other words, the curtain 502 of the illustrated example extends or spans across a width of the pit 28 (e.g., in the x-direction) and/or between lateral side walls 28a of the pit 28. The front seal 24 of the illustrated example is positioned adjacent the curtain 502. Specifically, the front seal 24 is positioned adjacent the upper edges 506 of the support posts 504. In the illustrated example, the front seal 24 extends or spans across the width W of the pit 28 and/or between lateral side walls of the pit 28 (e.g., in the x-direction). In some examples, the front seal 24 has a longitudinal length that is substantially equal to a width of the curtain 502 and/or the width W of the deck 14. In other words, the front seal 24 spans between the first bumper 42 and the second bumper 43.

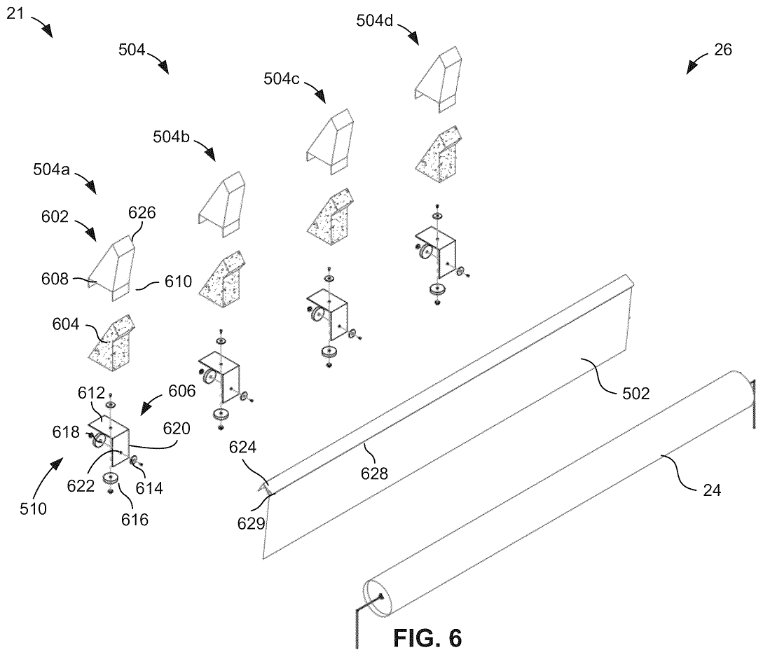

FIG. 6 is an exploded view of the example rear seal 26 of the example seal assembly 21 of FIGS. 2-5. The support posts 504 of the illustrated example include a first support post 504a, a second support post 504b, a third support post 504c, and a fourth support post 504d. The support posts 504 are substantially similar to each other. As such, descriptions of the first support post 504a can likewise apply to the second, third, and fourth support posts 504b-504d. Furthermore, although four of the support posts 504 are shown in the illustrated example, the seal assembly 21 can include more than four of the support posts 504 (e.g., six, eight, etc.) or less than four of the support posts 504 (e.g., three, two, etc.). In some examples, the seal assembly 21 includes a single one of the support posts 504 (e.g., positioned adjacent a midpoint of a width in the x-direction (FIG. 5)) and ends of the curtain 502 couple to the respective first and second bumpers 42, 43 or other structure(s) of the loading dock 12.

The first support post 504a includes a cover 602, an insert or core 604, and the fastener 510. In some examples, the core 604 is a foam core or body. The core 604 can be a compressible body that is resilient such that it can be compressed during impact and restored to its original shape or initial position when a force (e.g., the impact) is removed. For example, the core 604 of the illustrated example can include, but is not limited to, polyurethane foam, high density foam, lux foam, and/or any other compressible material(s). In some examples, the cover 602 is a fabric and/or leather sheath that can protect and/or contain the core 604. The cover 602 of the illustrated example can conform to (e.g. or formed with a shape complementary to) a shape of the core 604. For example, the cover 602 of the illustrated example encases or completely surrounds the core 604. To facilitate attachment of the cover 602 and the core 604, the cover 602 of the illustrated example includes a first tab 608 and a second tab 610.

In the illustrated example, the fastener 510 is a mounting bracket 606. The mounting bracket 606 of the illustrated example couples the first support post 504a to the loading dock 12. The mounting bracket 606 of the illustrated example has a first arm 612 and a second arm 614. For example, the mounting bracket 606 is an L-shaped bracket. To couple the mounting bracket 606 to the loading dock 12, the mounting bracket 606 of the illustrated example includes a first magnetic fastener 616 coupled to the first arm 612 and a second magnetic fastener 618 coupled to the second arm 614. Specifically, the mounting bracket 606 includes an outer surface or outer side 620 and an inner surface or inner side 622 opposite the outer side 620. The outer side 620 is oriented away from the pit floor 19 and the inner side 622 is oriented toward the pit floor 19 (FIGS. 2-4, 5A, 5B). The first magnetic fastener 616 and the second magnetic fastener 618 of the illustrated example are positioned on the inner side 622 of the mounting bracket 606. The first magnet fastener 616 and the second magnetic fastener 618 are coupled to the mounting bracket 606 via fasteners (e.g., screws, rivets, washers, etc.). In some examples, the releasable fastener can be a mounting bracket that extends across the pit 28 in the x-direction. In other words, instead of a plurality of mounting brackets 606, the fastener 510 can be a unitary structure or piece (e.g., an elongated bracket). In some examples, only one of the first magnetic fastener 616 or the second magnetic fastener 618 is employed to couple the support posts 504 to the loading dock 12 and/or the pit 28.

In the illustrated example, the curtain 502 includes a header 624 to couple the curtain 502 to the support posts 504 (e.g., the upper edges 506 of the support posts 504). More specifically, the header 624 can couple to an upper surface 626 of the cover 602. In some examples, the header 624 overlays the upper surface 626 and couples to one or more fasteners (e.g., hooks, snaps, magnets, Velcro pads, etc.) of the cover 602 that are disposed on the upper surface 626. The curtain 502 also includes an outer loop 628 that receives or encloses a stay 629 (e.g., a rod, a steel or plastic post, etc.) to provide a sealed interface between the curtain 502 and the dock leveler 10 (e.g., the deck 14 and/or the lip 16). In the illustrated example, outer loop 628 is coupled to and/or extends from the header 624. The stay 629 of the illustrated example provides support against forces of the dock leveler 10 acting on the outer loop 628. In some examples, the stay 629 is made of polyvinyl chloride (e.g., PVC pipe) and is enveloped in the outer loop 628.

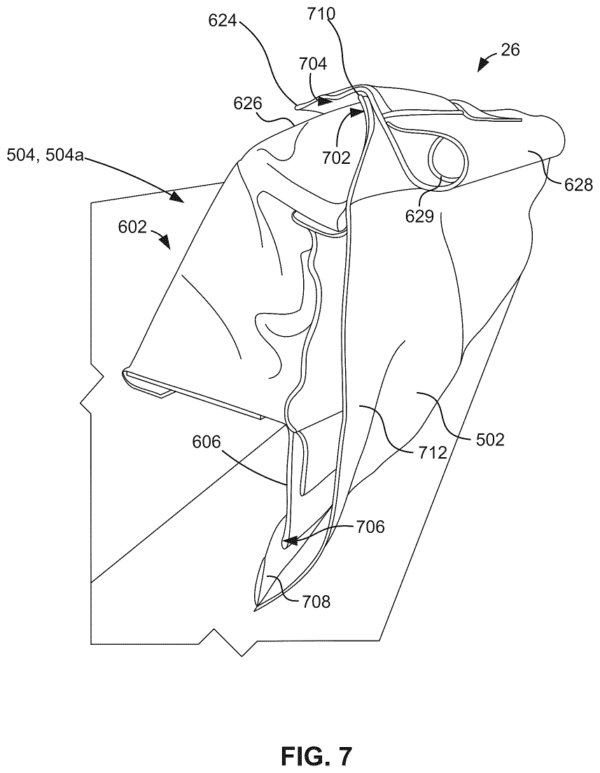

FIG. 7 is a perspective view of the rear seal 26 of the seal assembly 21 of FIGS. 2-6. The front seal 24 is omitted for clarity. In the illustrated example, the curtain 502 couples to the cover 602 of the support posts 504 (e.g., the first support post 504a as shown in FIG. 7) via a first fastener 702. To couple the header 624 and the upper surface 626 of the cover 602 of the support posts 504, the seal assembly 21 includes a second fastener 704. The header 624 of the illustrated example is positioned over an upper edge 710 of the curtain 502 such that the upper edge 710 of the curtain 502 is positioned between the cover 602 of the support posts 504 and the header 624. Additionally, the curtain 502 of the illustrated example includes a third fastener 706 to couple a lower edge 708 (e.g., a lowermost edge) of the curtain 502 to the loading dock 12 and/or the mounting bracket 606. In the illustrated example, the lower edge 708 of the curtain is coupled to the inner side of the mounting bracket 606 such that the lower edge of the curtain 502 is positioned between the mounting bracket 606 and the dock face 40. However, the mounting bracket 606 is positioned between a main portion 712 of the curtain 502 and the dock face 40, where the main portion 712 of the curtain 502 is between the lower edge 708 and the upper edge 710. The fasteners 702, 704, 706 of the illustrated example are releasable fasteners. Specifically, the fasteners 702, 704, 706 of the illustrated example are hook-and-loop fasteners. In some examples, the fasteners 702, 704, 706 can be other types of releasable fasteners, such as snaps, magnets, buckles, etc. and/or non-releasable fasteners such as, for example, adhesive, stitching, rivets, etc.

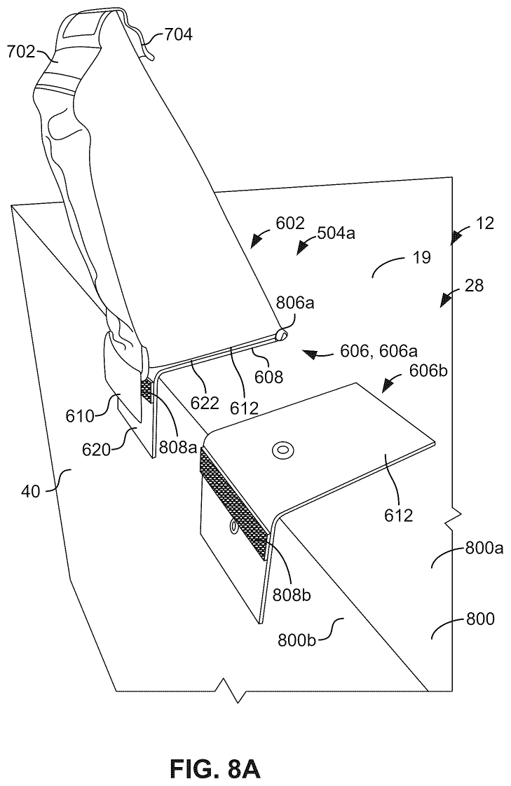

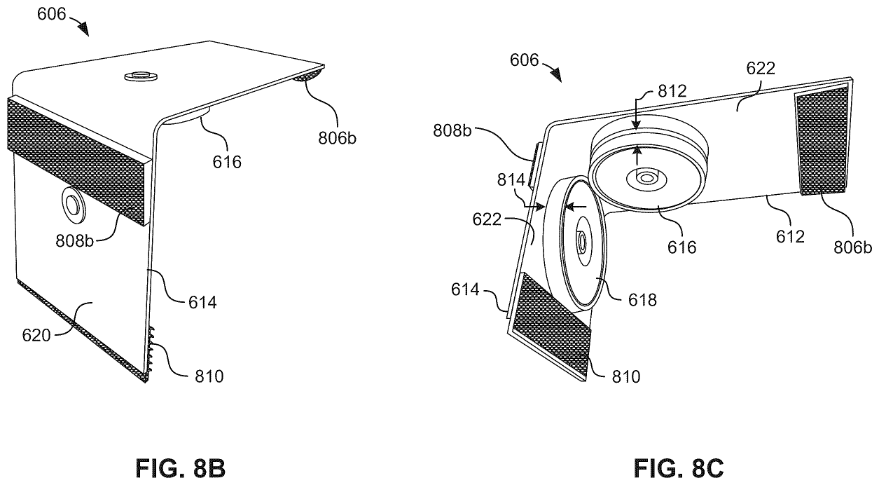

FIG. 8A is a perspective view of the first support post 504a of the seal assembly 21 of FIGS. 2-7. FIG. 8B is a perspective, front view of the mounting bracket 606 of the seal assembly 21 of FIGS. 2-8. FIG. 8C is a perspective, rear view of the mounting bracket 606 of FIG. 8A. In the illustrated example, the curtain 502 is not shown coupled to the first support post 504a.

When assembled, the core 604 of the first support post 504a is disposed within or covered by the cover 602. To retain the cover 602 fastened or secured to the core 604, the cover 602 of the illustrated example couples to the mounting bracket 606. The mounting bracket 606 of the illustrated example is coupled to the loading dock 12 via the first magnetic fastener 616 and the second magnetic fastener 618 (FIG. 6). For example, the pit 28 and/or the pit floor 19 includes a ferromagnetic material (e.g., a metal plate, an L-shaped plate or bracket) adjacent a lip or edge (e.g., a front edge) of the pit 28. For example, the pit 28 of the illustrated example includes a metal corner bracket 800 coupled (e.g., embedded with or fastened to) at a lip or edge defining a transition or corner between the dock face 40 and the pit floor 19 such that a first leg or portion 800a of the metal corner bracket 800 is on the pit floor 19 and a second leg or portion 800b of the metal corner bracket 800 is on the dock face 40. Because of the magnetic fastening of the mounting bracket 606, the first support post 504a is removably coupled to the loading dock 12 without use of any tools (e.g., power tools, hand tools, drills, etc.). As such, the first support post 504a can be placed anywhere along the width (x-axis) of the pit floor 19. In the illustrated example, the mounting bracket 606 is a first mounting bracket 606a. Furthermore, a second mounting bracket 606b for the second support post 504b (FIG. 6) is disposed adjacent to the first support post 504a to portray how the mounting brackets 606a, 606b are coupled to the loading dock 12.

In the illustrated example, the first support post 504a includes the first fastener 702 (FIG. 7). For example, the cover 602 includes a first part (e.g., a hook portion) of the first fastener 702 and the curtain 502 includes a second part (e.g., a loop portion) of the first fastener 702. Additionally, the first support post 504a includes the second fastener 704 (FIG. 7). The first fastener 702 is positioned on a first side or surface of the cover 602 and the second fastener 704 is positioned on a second side or surface of the cover 602 different (e.g., opposite) from the first side.

In the illustrated example, the first tab 608 folds over the first arm 612 of the mounting bracket 606. In other words, an end of the first tab 608 is positioned between the pit floor 19 and the first arm 612 of the mounting bracket 606 when the cover 602 is coupled to the core 604. Thus, the first tab 608 includes a first tab fastener 806a (e.g., loop fastener) to couple the cover 602 to the inner side 622 of the first arm 612 of the mounting bracket 606, which includes a first bracket fastener 806b (e.g., a hook fastener) to receive or couple to the first tab fastener 806a. Thus, the first tab 608 of the cover 602 couples to the outer side 620 of the first arm 612.

Additionally, the second tab 610 of the illustrated example includes a second tab fastener 808a (e.g., a loop fastener) to couple the cover 602 to the outer side 620 of the second arm 614 of the mounting bracket 606. The second arm 614 of the illustrated example includes a second bracket fastener 808b (e.g., a hook portion of the fastener) to receive or couple to the second tab fastener 808a. Thus, the second tab 610 of the cover 602 couples to the inner side 622 of the second arm 614.

In the illustrated example, the mounting bracket 606 includes the third fastener 706. Specifically, the mounting bracket 606 includes a third bracket fastener 810 positioned on the inner side 622 of the first arm 612. The third bracket fastener 810 is a first portion (e.g., hook portion) of the third fastener 706 that couples with a second portion (e.g., a loop portion) located at the lower edge 708 of the curtain 502 (FIG. 7).

In the illustrated examples, the first magnetic fastener 616 extends from the inner side 622 of the first arm 612 by a first height or first dimension 812. Additionally, the second magnetic fastener 618 extends from the inner side 622 of the second arm 614 by a second height or second dimension 814. In some examples, the first dimension 812 is the same as the second dimension 814. Because of the first and second dimensions 812, 814 of the first and second magnetic fasteners 616, 618, the first arm 612 is elevated or offset relative to the pit floor 19 and the second arm 614 is offset or spaced away from the dock face 40. As a result, the first tab 608 of the cover 602 and the lower edge 708 of the curtain 502 can fold over the respective first arm 612 and the second arm 614 of and be disposed between the inner side 622 of the mounting bracket 606 and the loading dock 12.

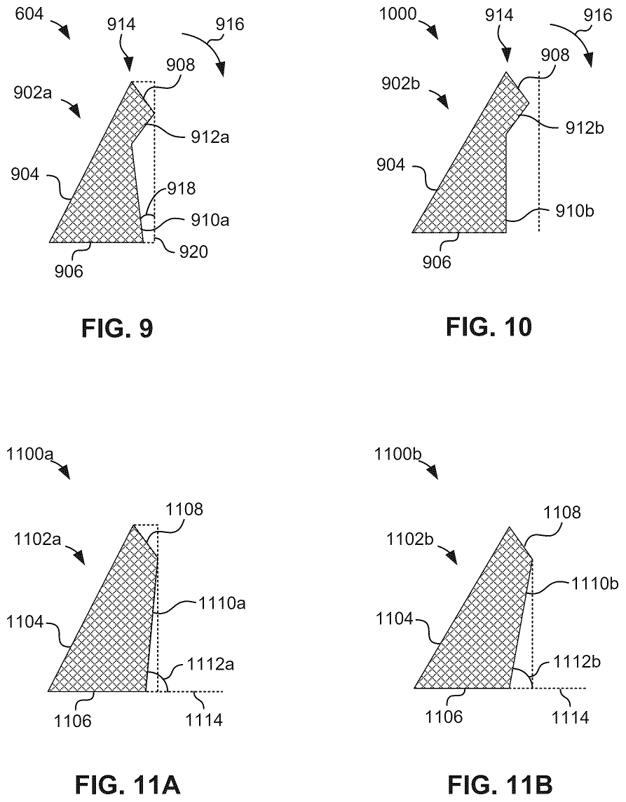

FIG. 9 is a side view of the example core 604 of FIG. 6. The first core 900a and the second core 900b include a rear surface 904, a base surface 906, and an upper surface 908. In the illustrated example of FIG. 9, a first core 900a has a first notched profile 902a. For example, the first core 900a of FIG. 9 includes a first lower front surface 910a and a first upper front surface 912a defining the first notched profile 902a. In some examples, the first notched profile 902a allows the core 604 to predictably collapse when the dock leveler 10 (e.g., the deck 14 and/or the lip 16) moves into a lowered position (lowered positions of FIGS. 18-20) and applies compressive forces on the support posts 504. For example, an upper portion 914 of the core 604 can bend or rotate in a first or clockwise rotational direction 916. For example, a notch provided by the first notched profile 902a enables the support posts 504 to collapse or compress in the forward direction 30. In such an example, the core 604 can bend into an example collapsed position. In the collapsed position, the first upper front surface 912a overlays the first lower front surface 910a. In some examples, the upper portion 914 of the core 604 can bend into the collapsed position without the rear surface 904 protruding rearward. Thus, the core 604 can ensure that the support posts 504 do not deform or crush in the rearward direction 32 underneath the dock leveler 10.

In the illustrated example of FIG. 9, the first lower front surface 910a is positioned at an angle 918 relative to a reference line 920. The example reference line 920 is orthogonal to the base surface 906. As such, the first lower front surface 910a slopes toward the rear surface 904 of the first core 900a.

FIG. 10 is a side view of another example core 1000 that can implement the seal assembly 21 of FIGS. 1-7. The core 1000 of FIG. 10 is substantially similar to the core 604 of FIG. 9. For example, the core 1000 include a rear surface 904, a base surface 906, and an upper surface 908. In the illustrated example of FIG. 10, a second core 900b has a second notched profile 902b. The second core 900b of FIG. 10, includes a second lower front surface 910b and a second upper front surface 912b defining the second notched profile 902b. In contrast to the core 604, the second lower front surface 910b of the core 1000 of FIG. 10 is substantially orthogonal to the base surface 906. A notch provided by the second notched profile 902b provide the same or similar functionality as the first notched profile 902a of FIG. 9.

FIGS. 11A and 11B are other example cores 1100a and 1100b that can implement the seal assembly 21 of FIGS. 1-7. In the illustrated example of FIG. 11A, a first core 1100a has a first trapezoidal profile 1102a. In the illustrated example of FIG. 11B, a second core 1100b has a second trapezoidal profile 1102b. For example, the first core 1100a and the second core 1100b include a rear surface 1104, a base surface 1106, and an upper surface 1108. The first core 1100a of FIG. 11A includes a first front surface 1110a defining the first trapezoidal profile 1102a. The second core 1100b of FIG. 11B, includes a second front surface 1110b defining the second trapezoidal profile 1102b. In the illustrated example of FIG. 11A, the first front surface 1110a is positioned at a first angle 1112a relative to a reference line 1114. In the illustrated example of FIG. 11B, the second front surface 1110b is positioned at a second angle 1112b relative to the reference line 1114. The example reference line 1114 is parallel to and aligned with the base surface 1106. As such, the first and second front surfaces 1110a, 1110b slope away from the rear surface 1104. In the illustrated examples of FIGS. 11A and 11B, the first angle 1112a is greater than the second angle 1112b.

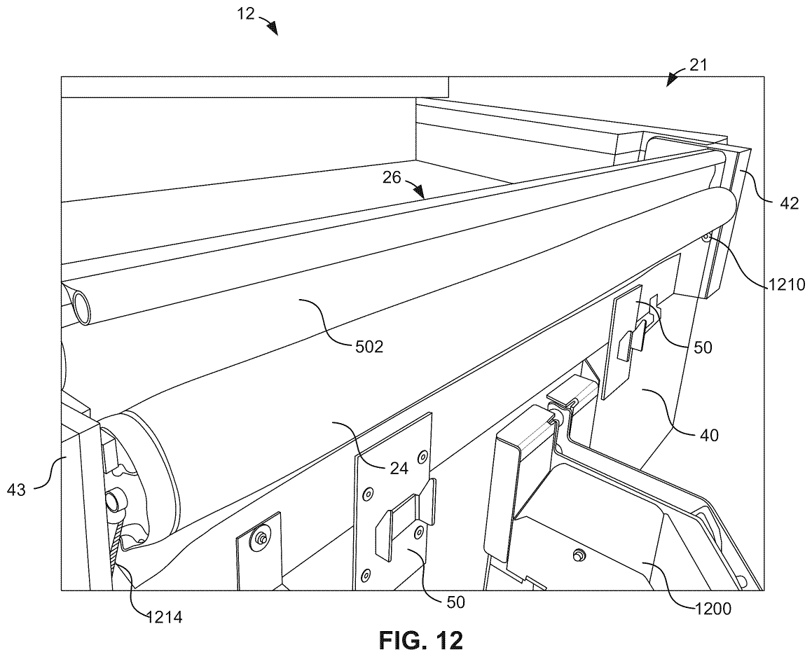

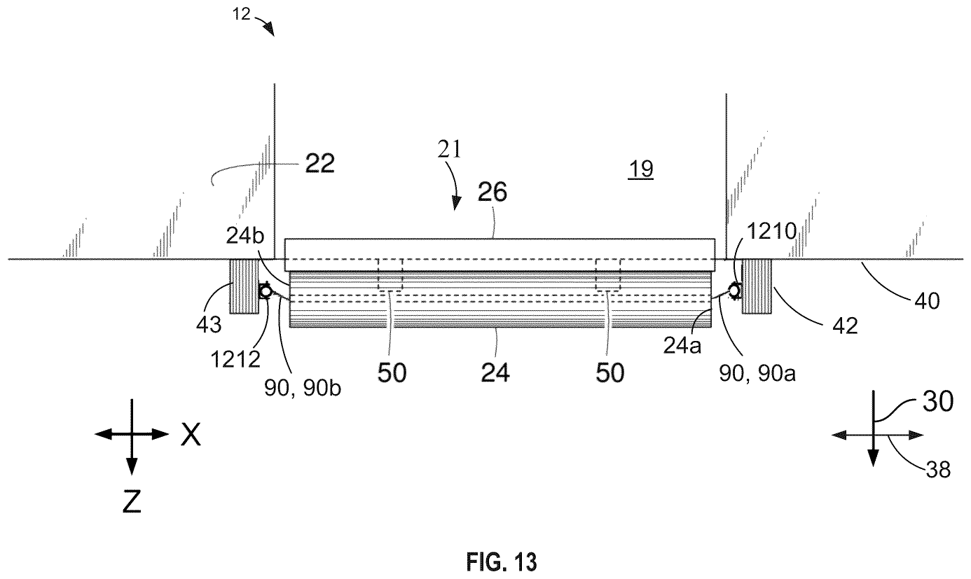

FIG. 12 is another perspective view of the loading dock 12 and the example seal assembly 21 of FIGS. 1-7. As shown in FIG. 12, the loading dock 12 includes a vehicle restraint 1200 to restrain the vehicle 20 (FIG. 1). The lip keepers 50 are spaced or separate from the bumpers 42, 43. FIG. 13 is a top view of the example loading dock 12 of FIGS. 1-7. The front seal 24 of the illustrated example is coupled or suspended from the loading dock 12 via the mounting system 420.

Referring to FIGS. 12 and 13, to suspend the front seal 24 relative to the loading dock 12, the mounting system 420 of the illustrated example includes the tension member 90, the first mounting bracket 1210, and the second mounting bracket 1212. As used here, a tension member includes a string, a cord, a cable, a rope (e.g., nylon, polypropylene, polyester, etc.) another type of malleable line of another material (e.g., metallic cable, bungee cord, etc.), and/or any other structure to suspend the front seal 24 relative to the rear seal 26 and/or loading dock 12.

The first mounting bracket 1210 couples or attaches a first end 24a of the front seal 24 to a first anchor of the loading dock 12 and the second mounting bracket 1212 couples or attaches a second end 24b of the front seal 24 opposite the first end 24a to a second anchor of the loading dock 12. In the illustrated example, the first anchor of the illustrated example is the first bumper 42 and the second anchor of the illustrated example is the second bumper 43. Specifically, a first portion 90a of the tension member 90 is coupled to the first mounting bracket 1210 (e.g., which is coupled to the first bumper 42) and a second portion 90b of the tension member 90 is coupled to the second mounting bracket 1212 (e.g., which is coupled to the second bumper 43). However, in some examples, the first mounting bracket 1210 and/or the second mounting bracket 1212 can mount to a wall, frame or other structure of the loading dock 12, the pit 28, and/or any other structure of the loading dock 12. As described in greater detail below, the front seal 24 moves relative to the rear seal 26. For example, the mounting brackets 1210, 1212 and/or the tension member 90 enable the front seal 24 to move relative to the rear seal 26 in the forward direction 30, the rearward direction 32, the upward direction 34, the downward direction 36, the lateral direction 38, and/or any combination thereof.

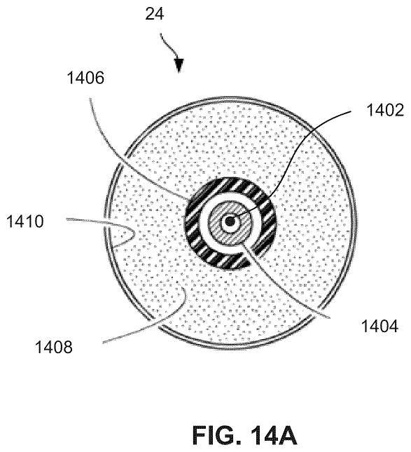

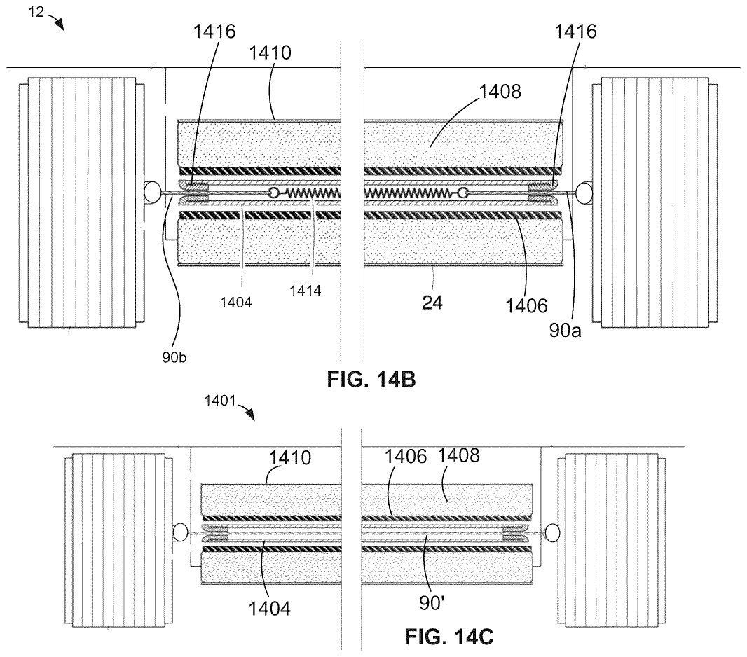

FIG. 14A is a cross-sectional view of the front seal 24 of the seal assembly 21 of FIGS. 2-7. FIG. 14B is a cross-sectional view of the example front seal 24 coupled to the loading dock 12. The front seal 24 is horizontally elongate to define a longitudinal axis 1402. The front seal 24 includes an axle 1404, an outer tube 1406, a resiliently compressible foam member 1408 (e.g., polyurethane foam), and a flexible cover 1410 (e.g., fabric, vinyl, etc.). The axle 1404 is a relatively stiff metal tube (e.g., a pipe). The compressible foam member 1408 is disposed around the outer tube 1406. The outer tube 1406 is radially supported by the axle 1404 and can rotate relative to the axle 1404 about the longitudinal axis 1402 (e.g., a center of rotation). In some examples, the outer tube 1406 is made of polyvinyl chloride (e.g., PVC pipe).

The mounting system 420 of the illustrated example includes a biasing element 1414 (e.g., an extension spring, an elongated spring, etc.) coupled to (e.g., installed within) the axle 1404 of the front seal 24. The tension member 90 (e.g., a cable) extends through a central bore in a connector or retainer 1416 (e.g., a bushing) to connect the biasing element 1414 to a substantially stationary anchor point (e.g., the first mounting bracket 1210 and the second mounting bracket 1212). For example, the tension member 90 of the illustrated example couples to the axle 1404. For example, respective inner ends of the first portion 90a and the second portion 90b of the tension member 90 are coupled to the biasing element 1414 and respective outer ends of the first portion 90a and the second portion 90b couple to the mounting system 420. For example, a first outer end of the first portion 90a of the tension member 90 couples to the first mounting bracket 1210 and outer end of the second portion 90b of the tension member 90 couples to the second mounting bracket 1212. The retainers 1416 retain the biasing element 1414 coupled to the axle 1404. Each of the retainers 1416 (e.g., an outer surface of the retainers 1416) includes a threaded outer surface to couple to the outer tube 1406. The biasing element 1414 provides tension to the tension member 90 to urge the front seal 24 to a position (e.g., an initial position) shown in FIGS. 2-7, 12, and 13. The front seal 24 can move relative to the bumpers 42, 43 and/or the rear seal 26 via the biasing element 1414.

FIG. 14C is a cross-sectional view of another example front seal 1401 that can implement the front seal 24 disclosed herein. The example front seal 1401 of the illustrated example is substantially similar to the front seal 24 of FIG. 14B. For example, the front seal 1401 includes an axle 1404, an outer tube 1406, a resiliently compressible foam member 1408 (e.g., polyurethane foam), and a flexible cover 1410 (e.g., fabric, vinyl, etc.). However, the front seal 1401 of the illustrated example includes a substantially, unitary tension member 90′ (e.g., a single rope or cord) and does not include the biasing element 1414 of FIG. 14B. The unitary tension member 90′ horizontally extends through the axle 1404 of the front seal 24.

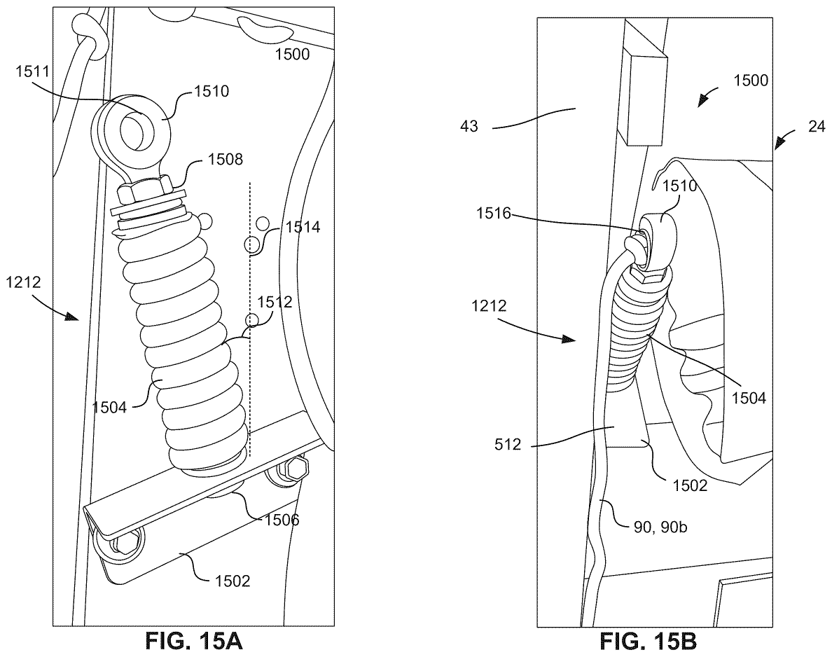

FIG. 15A is a perspective, side view of an example flexible mount 1500 (e.g., a flexible or bendable bracket) of the seal assembly 21 of FIGS. 2-6. The example flexible mount 1500 can implement the first mounting bracket 1210 and/or the second mounting bracket 1212 of the mounting system 420 of FIGS. 2-7, 12, 13, 14A-14C. The flexible mount 1500 includes a rigid base 1502, a spring 1504, a first fastener 1506, a second fastener 1508, and an axle support bearing 1510. The axle support bearing 1510 includes an aperture 1511 (e.g., an eyelet) to receive an end of the tension member 90. When anchored to the bumpers 42, 43, the rigid base 1502 is oriented at an angle 1512 relative to a vertical reference line 1514 (e.g., in the y-direction). Thus, the spring 1504 tilts in the forward direction 30 (FIG. 4) and away from the loading dock 12. The spring 1504 is relatively flexible and can bend in various directions. As such, when the vehicle 20 backs into the front seal 24 the spring 1504 allows the front seal 24 to move in the rearward direction 32 (FIG. 3) and press into the lip 16 (FIG. 3). The angle 1512 of the flexible mount 1500 helps ensure that the vehicle 20 does not contact the rigid base 1502, the dock face 40 (FIGS. 2-4), or another component of the loading dock 12. Thus, the angle 1512 of the flexible mount 1500 causes the vehicle 20 to first contact the front seal 24 rather than another component of the seal apparatus 21. The axle 1404 (FIG. 14) of the front seal 24 is rotatably coupled to the axle support bearing 1510. Thus the front seal 24 can rotate freely relative to the flexible mount 1500. The flexible mount 1500 is angled such that the axle support bearing 1510 is positioned forward of (e.g., in the forward direction 30 of FIG. 3) the first fastener 1506. Thus, the first fastener 1506 is positioned closer to the dock face 40 or the pit 28 in the z-direction than the axle support bearing 1510. Additionally, the axle support bearing 1510 is located above the first fastener 1506 in the y-direction.

FIG. 15B is a perspective, front view of the flexible mount 1500 of FIG. 15A with a portion of the front seal 24 coupled to the loading dock 12. In the illustrated example the flexible mount 1500 is a first flexible mount 1500 implemented as the second mounting bracket 1212 of FIG. 5A. The first mounting bracket 1210 is identical to the second mounting bracket 1212. As such, a first end of the first portion 90a of the tension member 90 is coupled to a first flexible mount 1500 defining the first mounting bracket 1210 and a second end of the second portion 90b of the tension member 90 opposite the first end is attached to a second flexible mount 1500 defining the second mounting bracket 524.

In the illustrated example, an end of the second portion 90b of the tension member 90 is positioned through the aperture 1511 of the axle support bearing 1510. To retain the end of the tension member 90 coupled to the axle support bearing 1510, a washer 1516 is positioned adjacent the aperture 1511 of the axle support bearing 1510 and the end of the tension member 90 is knotted to a size that is greater than a diameter of the aperture 1511 and/or a washer 1516, thereby preventing and/or restricting the end of the tension member 90 from decoupling from the aperture 1511 of the axle support bearing 1510. In some examples, the axle 1404 (FIG. 14) can be coupled to the axle support bearing 1510 via a fastener (e.g., pin, rod, bolt, etc.).

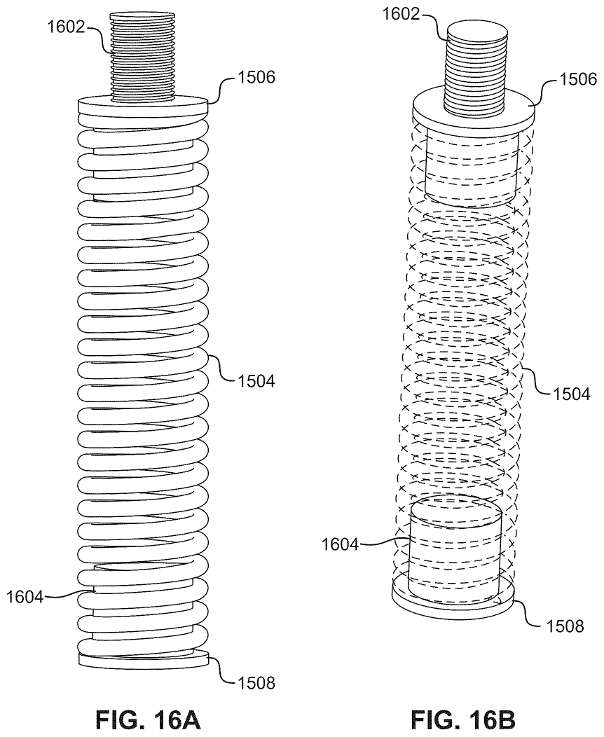

FIG. 16A a perspective view of a portion of the flexible mount 1500 of FIGS. 15A and 15B. FIG. 16B is a perspective view of the portion of the flexible mount 1500 of FIG. 16A but with the spring 1504 shown in phantom or semi-transparent state. The first fastener 1506 and the second fastener 1508 are coupled to the spring 1504. In some examples, the first fastener 1506 and the second fastener 1508 are welded to the spring 1504. In the illustrated example, the first fastener 1506 includes a threaded male portion 1602. In the illustrated example, the second fastener 1508 includes a female threaded portion 1604. In some examples, the first fastener 1506 couples to the rigid base 1502 (FIGS. 15A and 15B) with a threaded nut fastened to the threaded male portion 1602. In some examples, the axle support bearing 1510 is an eye bolt with a threaded male portion. Thus, the threaded male portion of the axle support bearing 1510 can fasten to the female threaded portion 1604 to couple the axle support bearing 1510 to the second fastener 1508.

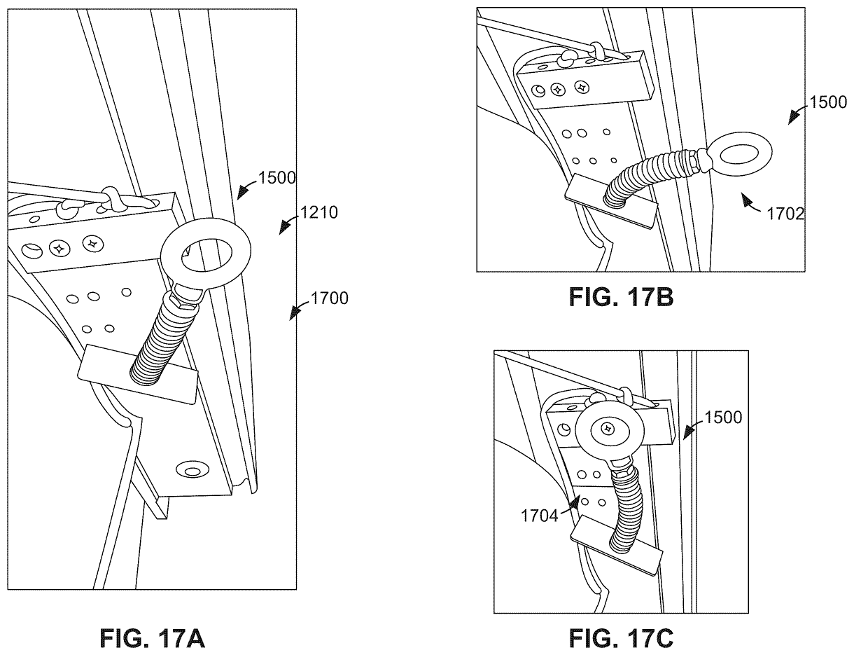

FIG. 17A is a perspective view of the flexible mount 1500 of FIGS. 15A and 15B in a non-deflected position 1700. The non-deflected position 1700 occurs when no external force(s) is imparted to the flexible mount 1500. In other words, the non-deflected position 1700 of the illustrated example can be an initial position. FIG. 17B is a perspective view of the flexible mount 1500 of FIGS. 15A and 15B in a forward deflected position 1702. FIG. 17C is a perspective view of the flexible mount 1500 of FIGS. 15A and 15B in a rearward deflected position 1704. When the dock leveler 10 is in a raised position (FIG. 4), the flexible mount 1500 is in a neutral or disengaged position of FIG. 17A. When the dock leveler 10 is in a lowered position (e.g., cross-traffic position (FIG. 19), below dock position (FIG. 20), etc.), the lip 16 can push the front seal 24 in the forward direction 30 (FIG. 4) and cause the flexible mount 1500 to bend toward the forward deflected position 1702. When the vehicle 20 backs into the seal apparatus 21, the vehicle 20 can push the front seal 24 in the rearward direction 32 (FIG. 4). Thus, the vehicle 20 can cause the flexible mount 1500 to bend toward the rearward deflected position 1704. In other words, the spring 1504 enables the flexible mount 1500 to bend between the forward deflected position 1702 and the rearward deflected position 1704. Furthermore, the flexible mount 1500 enables the front seal 24 to move in the forward direction 30, the rearward direction 32, the upward direction 34, the downward direction 36 and/or the lateral direction 38, and/or any combination thereof) relative to the dock face 40 and/or the rear seal 26 (FIGS. 2-4).

FIGS. 18-20 illustrate various cross-traffic positions during loading and/or unloading operations. During loading and/or unloading operations, the dock leveler 10 can be positioned at various positions relative to the vehicle cargo bed 18 as shown, for example, in FIGS. 18-22. For example, FIG. 18 illustrates the dock leveler 10 at an example standard loading position 1800. FIG. 19 illustrates the dock leveler 10 at an example cross-traffic position 1900 (e.g., a substantially horizontal position). FIG. 20 illustrates the dock leveler 10 at a below-dock position 2000 (e.g., a fully lowered position). For example, to employ the dock leveler 10 for vehicle-end loading and/or vehicle-end unloading operations, the deck 14 can be positioned to the cross-traffic position 1900 of FIG. 19 or the below-dock position 2000 of FIG. 20.

When the deck 14 and the lip 16 are in the various operational positions 1800-2000 shown in FIGS. 18-20 during loading and/or unloading operations, the seal assembly 21 of the illustrated example seals (e.g., closes or obstructs) air gaps that can otherwise form between the dock face 40 and the rear edge 66 of the vehicle 20. For example, the front seal 24 and/or the rear seal 26 shelter the pit 28 from environmental elements (e.g., outdoor weather, snow, rain, etc.) and/or debris by blocking an air gap that might otherwise exist between a front edge 64 of the pit 28 and the rear edge 66 of the vehicle 20. Additionally or alternatively, the seal assembly 21 of the illustrated example seals against elements (e.g., air) flowing between an interior of the building of the loading dock 12 and an exterior of the building through the pit 28 via a flow path around side edges of the dock leveler 10. In other words, the example seal assembly 21 disclosed herein restricts or prevents airflow through the pit 28 during a loading/unloading operation.

For example, FIG. 18 is a side view of the loading dock 12 with the dock leveler 10 in the standard loading position 1800. In the standard loading position 1800, the deck 14 is in a first lowered position 1802 and the lip 16 is in an extended position 1804 (e.g., a fully extended position) and at least partially positioned on the vehicle cargo bed 18. Although not shown in FIG. 18, the rear impact guard 68 of the vehicle 20 is in engagement with the vehicle restraint 1200 of FIG. 12. To move the dock leveler 10 to the standard loading position 1800, one or more actuators move the lip 16 to the extended position 1804 and lower the deck 14 so that the lip 16 rests on the vehicle cargo bed 18. With the dock leveler 10 positioned in the standard loading position 1800, a fork truck or other vehicle can transfer cargo between the platform 22 and the vehicle cargo bed 18 via the dock leveler 10.

In the standard loading position 1800, the front seal 24 and the rear seal 26 of the illustrated example are positioned beneath or below (e.g., at an underside of) the deck 14 and the lip 16. Additionally, the front seal 24 of the illustrated example engages the rear edge 66 of the vehicle 20 to close an air gap that would otherwise exist between the rear edge 66 of the vehicle 20 and a front edge 64 of the pit 28 and/or the dock face 40. In some examples, the front seal 24 and the rear seal 26 are horizontally elongate and extend substantially across a full width of the deck 14 and the lip 16 (e.g., in the x-direction). In some examples, the front seal 24 and/or the rear seal 26 extend a distance that is less than a full width of the deck 14 or extend a distance that is greater than a full width of the deck 14.

FIG. 19 is a cross-sectional side view of the loading dock 12 with the dock leveler 10 in the example cross-traffic position 1900. In the cross-traffic position 1900 of FIG. 19, the deck 14 is substantially parallel relative to the vehicle cargo bed 18. Additionally, the deck 14 is in a partially lowered position 1902, and the lip 16 is in a retracted position 1904 (e.g., a fully retracted or stored position, a pendent position). For example, the lip 16 is positioned substantially perpendicular relative to the deck 14. As used herein, substantially parallel means perfectly parallel or approximately parallel (e.g., within 10 degrees or 10 percent of perfectly parallel). As used herein, substantially perpendicular means perfectly perpendicular or approximately perpendicular (e.g., within 10 degrees or 10 percent of perfectly perpendicular).

As the deck 14 moves between (e.g., lowers from) the stored position 300 of FIG. 3 to the cross-traffic position 1900 of FIG. 19, the lip 16 of the dock leveler 10 is in the retracted position 1904 and engages the seal apparatus 21. Specifically, the lip 16 of the illustrated example is positioned (e.g., sealingly pressed) between the front seal 24 and the rear seal 26. For example, the rear seal 26 sealingly engages a rear surface 133 (FIG. 20) of the lip 16 and the front seal 24 sealingly engages a front surface 120 (FIG. 20) of the lip 16. In the illustrated example, the front seal 24, the lip 16 and/or the rear seal 26 closes a gap between the rear edge 66 of the vehicle 20 and the front edge 64 of the pit 28. For example, the front seal 24 and the rear seal 26 close, block or reduce a gap between a front surface of the lip 16 and the rear edge 66 of the vehicle 20. Additionally, the curtain 502 provides a barrier to prevent airflow between an interior of the building and an exterior of the building via a gap formed by the front hinge 58 when the lip 16 is in the pending position 1904.

The mounting system 420 enables the lip 16 to be positioned between the front seal 24 and the rear seal 26 without causing damage to the rear seal 26 and/or the front seal 24 as the lip 16 engages the front seal 24 and the rear seal 26. Specifically, the mounting system 420 of the illustrated example enables the front seal 24 to shift (e.g., in the forward direction 30, the rearward direction 32, the upward direction 34, the downward direction 36 and/or the lateral direction 38, and/or any combination thereof) relative to the dock face 40 and/or the rear seal 26. Additionally, the rear seal 26 can compress or deflect relative to the dock face 40 and/or the front seal 24. Thus, the front seal 24 can separate or shift relative to the rear seal 26 to allow the lip 16 to be positioned between the front seal 24 and the rear seal 26. In some examples, the mounting system 420 of the illustrated example biases the front seal 24 into sealing engagement with the lip 16.

FIG. 20 is a cross-sectional side view of the loading dock 12 with the dock leveler 10 in the example below-dock position 2000 (e.g., a fully lowered position). When the loading dock 12 is in the below-dock position 2000, the deck 14 of the illustrated example is in a fully lowered position 2002 and positioned at an angle (e.g., a downward sloping angle toward the vehicle 20). Furthermore, in the illustrated example of FIG. 20, the lip 16 is positioned between the front seal 24 and the rear seal 26 at a partially extended or retracted position 2004. In the fully lowered position 2002 deck 14 slopes downward from the rear edge 52 of the deck to the front edge 55 of the deck 14. When deck 14 is at the fully lowered position 2002 and the lip 16 is the partially extended position 2004 as shown in FIG. 20, the lip 16 is positioned in front of the lip keepers 50. To support the deck 14 and/or prevent damage to components (e.g., hydraulic components, motors, etc.) stored underneath the deck 14 when the deck 14 is in the fully lowered position 2002 of FIG. 20, the dock leveler 10 of the illustrated example includes the stump out legs 60. Additionally, the stump out legs 60 are aligned with the gaps or spaces between the respective supporting posts 504 of FIGS. 4-5. In this manner, the support posts 504 do not interfere with the stump out legs 60. In the illustrated example, the front seal 24, the lip 16 and/or the rear seal 26 closes a gap between the rear edge 66 of the vehicle 20 and the front edge 64 of the pit 28. For example, the front seal 24 closes, blocks or reduces a gap between a front surface of the lip 16 and the rear edge 66 of the vehicle 20 and the rear seal 26 closes, blocks or reduces a gap formed by the front hinge 58 between the deck 14 and the lip 16.

An end-loading operation as shown in FIGS. 19 and 20 can be employed during loading and/or unloading operation when a floor space of the vehicle cargo bed 18 is inadequate to receive the lip 16 (e.g., when there is no available floor space to rest the lip 16 on the vehicle cargo bed 18). For example, this instance can arise when a load of cargo is adjacent or near the rear edge 66 (e.g., the very back end) of the vehicle 20. In these instances, the lip 16 cannot be positioned on the vehicle cargo bed 18 and is positioned in a retracted position (e.g., the retracted position 1904 of FIG. 19 or the partially retracted position 2004 of FIG. 20) based on a height of vehicle cargo bed 18 relative to the platform 22. If an elevation of the vehicle cargo bed 18 is equal to or higher than the platform 22, then deck 14 can be placed at the partially lowered position 1902 (FIG. 19) with the lip 16 resting on the lip keepers 48. If the vehicle cargo bed 18 is at an elevation that is lower than the platform 22, then the deck 14 is lowered or angled down to the fully lowered position 2002 (FIG. 20) and the lip 16 is in a partially extended position in front of the lip keepers 48.

After a loading and/or unloading operation is complete, the dock leveler 10 is positioned to the stored position 300 of FIG. 3 (e.g., a fully raised position). When the dock leveler 10 rises from the cross-traffic position 1900 of FIG. 19 or the below-dock position 2000 of FIG. 20, the lip 16 moves upwardly (e.g., in the upward direction 34) and away (e.g., out) from between the front seal 24 and the rear seal 26. As the lip 16 rises (e.g., in the upward direction 34), the lip 16 moves (e.g., pushes) the front seal 24 relative to the rear seal 26 (e.g., in the forward direction 30 and/or the upward direction 34). To prevent damage to the front seal 24, the front seal 24 of the illustrated example includes the axle 1404 of FIG. 14. The axle 1404 of the illustrated example is configured to allow the front seal 24 to rotate about the longitudinal axis 1402 (FIG. 14) of the front seal 24 when the lip 16 moves from between the front seal 24 and the rear seal 26.

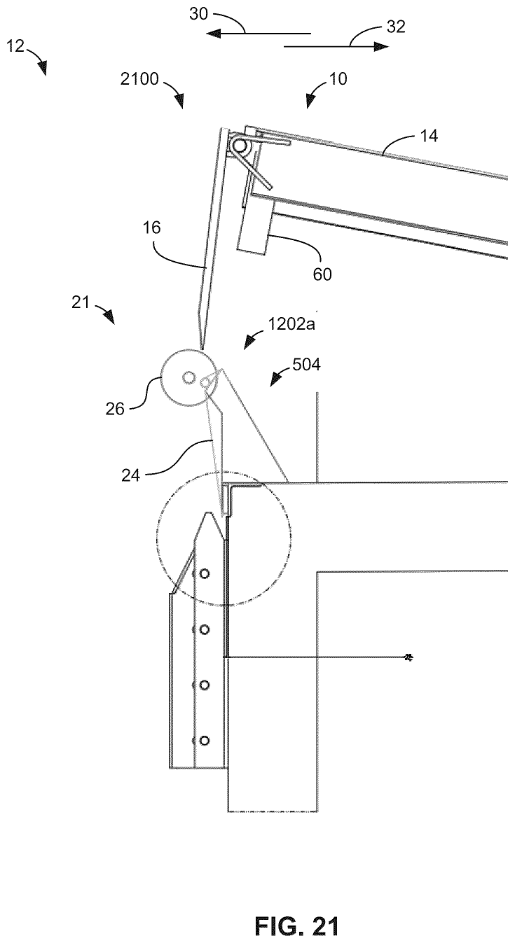

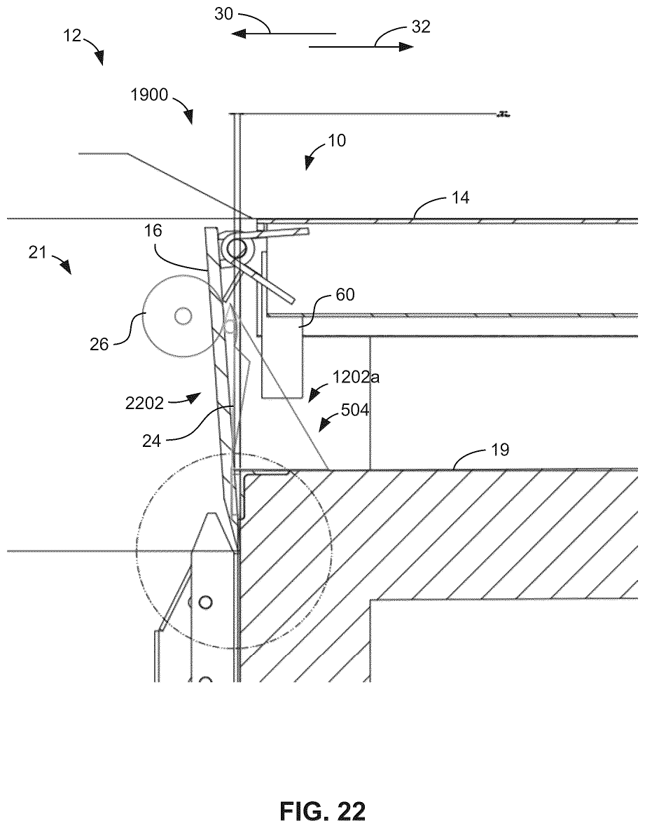

FIG. 21 is a cross-sectional side view of the loading dock 12 of FIGS. 2-7 and 18-20 with the dock leveler 10 in an intermediate position 2100. FIG. 22 is a cross-sectional side view of the loading dock 12 of FIGS. 2-7 and 18-20 with the dock leveler 10 in the cross-traffic position 1900 of FIG. 19. The support posts 504 are angled relative to vertical or the upward direction 34 (FIG. 3). In the illustrated example, the support posts 504 include the first notched profile 1202a of FIG. 9. Thus, the support posts 504 can bend, compress, and/or tilt from interaction with the lip 16.

In the illustrated example, compressive forces from the dock leveler 10 cause the support posts 504 to bend into a collapsed position 2202 as shown, for example, in FIG. 22. When the dock leveler 10 is lowered, and the lip 16 is positioned between the front seal 24 and the rear seal 26, the support posts 504 can bend due to the first notched profiles 1202a. As such, the support posts 504 do not bend in the rearward direction 32 into the deck 14, but instead rotate in the forward rotational direction 916 (FIG. 9). Thus, deck 14 does not cause the support posts 504 to detach from the pit floor 19 when the dock leveler 10 moves into a lowered position. Furthermore, cross-sectional profiles of the support posts 504 (e.g., the first or second notched profiles 902, 902b of FIGS. 9-10, the first or second trapezoidal profiles 1102a, 1102b of FIGS. 11A-11B, etc.) reduce wear that may occur over time due to repeated compression/decompression from lowering/raising the dock leveler 10.

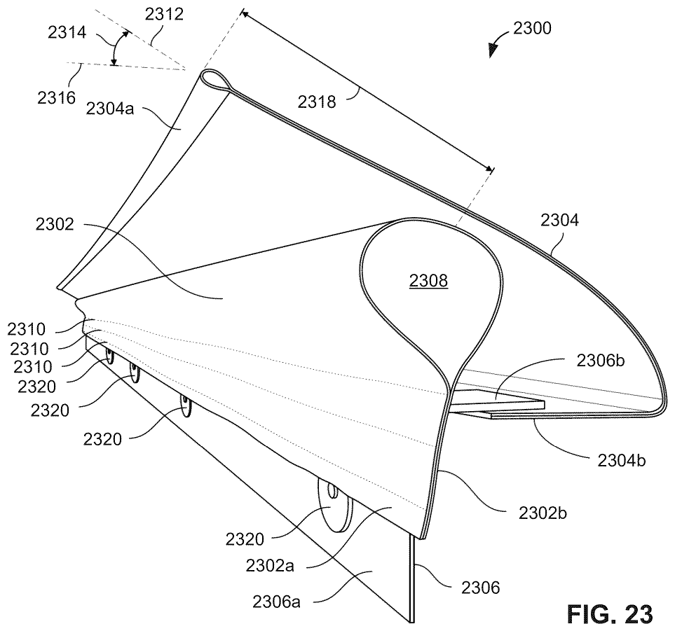

FIG. 23 is a perspective view of an example bulb seal or rear seal 2300 that can be implemented in the seal assembly 21 of FIGS. 2-6. In some examples, the rear seal 2300 can be used in place of the rear seal 26 of FIGS. 2-7. The rear seal 2300 of the illustrated example includes a compressible core 2302, a cover 2304, and a rear seal mounting bracket 2306 (e.g., a unitary, single structure bracket). The compressible core 2302 of the illustrated example is a bulb seal. For example, the compressible core 2302 of the illustrated example defines a cavity 2308 (e.g., a collapsible cavity) extending (e.g., completely) between the respective ends of the rear seal 2300. The compressible core 2302 of the illustrated example is formed from a flexible material or fabric (e.g., vinyl, a flexible plastic, etc.) For example, the compressible core 2302 can be formed of foam, rubber, a compressible material, a resilient material, and/or any other suitable material(s). Additionally, the compressible core 2302 of the illustrated example is formed from a unitary sheet of material. To form the compressible core 2302, a first end 2302a of the flexible material defining the compressible core 2302 is folded over relative to a second end 2302b of the flexible material defining the compressible core 2302. In other words, the first end 2302a of the illustrated example is positioned adjacent to the second end 2302b. The first end 2302a is attached or coupled to the second end 2302b. For example, the first end 2302a is coupled to the second end 2302b via one or more fasteners 2310. The fasteners 2310 of the illustrated example are sewing stitches. Thus, the first end 2302a of the illustrated example is sewn to the second end 2302b via one or more fasteners 2310 (e.g., sewing stitches) to form the compressible core 2302. However, in other examples, the one or more fasteners 2310 can include adhesive, hook-and-loop fasteners, and/or any other fastener(s). The compressible core 2302 forms a resilient, deformable seal. For example, the compressible core 2302 deforms when the vehicle 20 and/or the dock leveler 10 engages the seal apparatus 21. For example, the cavity 2308 of the compressible core 2302 of the illustrated example is an air cavity and can collapse during a loading and/or unloading operation. The compressible core 2302 has a resilient characteristic and returns to a non-deformable position or shape when the vehicle 20 and/or the dock leveler 10 disengage the rear seal 2300.

The cover 2304 is composed of a resilient material and includes a first end 2304a and a second end 2304b opposite the first end 2304a. The first end 2304a of the cover 2304 projects outwardly (e.g., is cantilevered) in a direction away from the dock face 40 (FIGS. 2-4). For example, a longitudinal axis 2312 of the first end 2304a extends from the compressible core 2302 at an angle 2314 from orthogonal 2316. In some examples, the angle 2314 can be approximately between 5 degrees and 15 degrees. Additionally, the first end 2304a of the cover 2304 extends from the compressible core 2302 a distance 2318. The distance 2318 of the illustrated example can be between approximately six inches and two feet. In some examples, the first end 2304a is cantilevered from the compressible core 2302.

To mount the rear seal 2300 to the loading dock 12, the rear seal 2300 includes the rear seal mounting bracket 2306. The rear seal mounting bracket 2306 has a first leg 2306a and a second leg 2306b (e.g., an L-bracket). The first leg 2306a mounts the rear seal 2300 to the dock face 40 via the first leg 2306a of the rear seal mounting bracket 2306. The first leg 2306a supports fasteners 2320 to mount the compressible core 2302 to the loading dock 12. The second leg 2306b couples the second end 2304b of the cover 2304 to the loading dock 12.

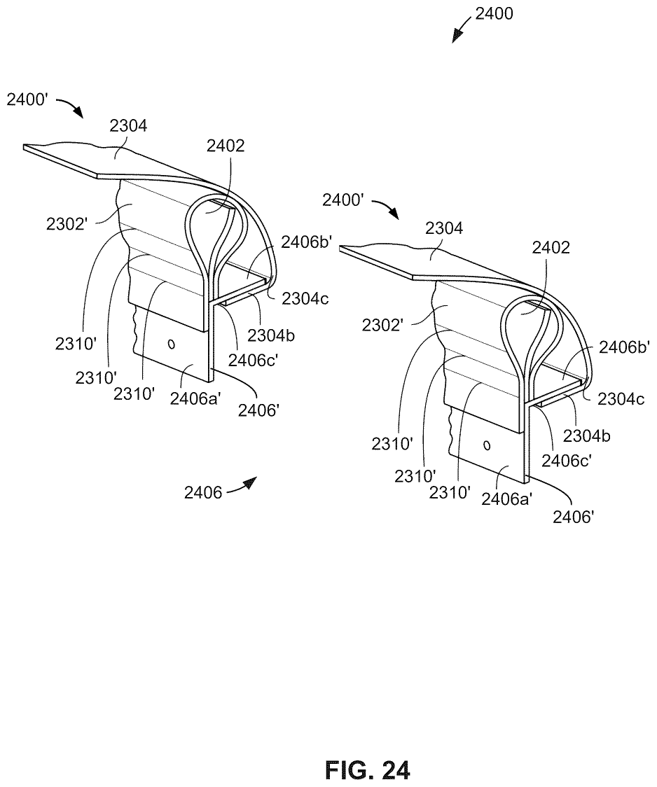

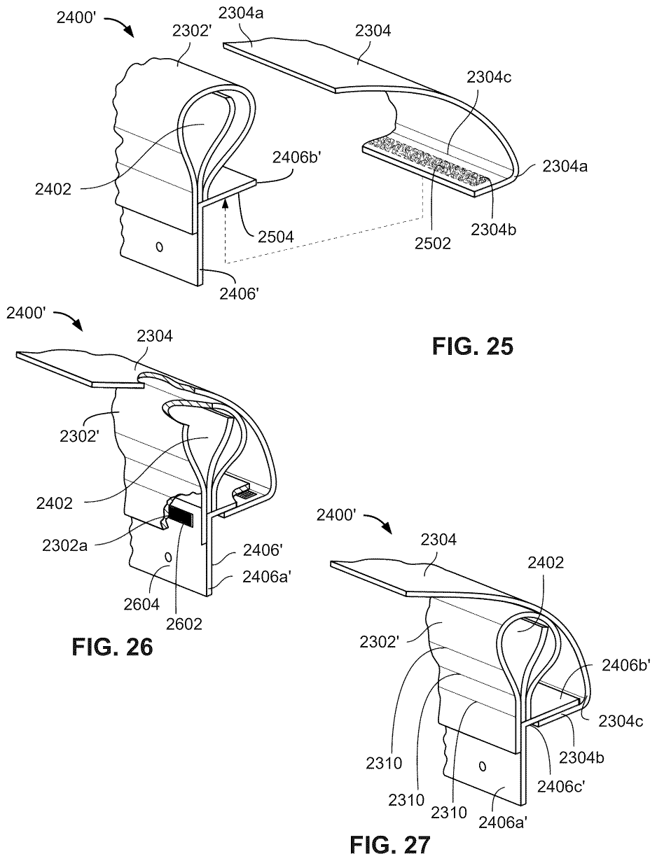

FIG. 24 is perspective view of another example bulb seal or rear seal 2400 that can implement the seal assembly 21 disclosed herein. FIGS. 25-27 are perspective, partially assembled views of the example rear seal 2400 of FIG. 24. In some examples, the rear seal 2400 can be used in place of the rear seal 26 of FIGS. 2-7. Many of the components of the example rear seal 2400 of FIGS. 24-27 are substantially similar or identical to the components described above in connection with the rear seal 2300 of FIG. 23. As such, those components will not be described in detail again below. Instead, the interested reader is referred to the above corresponding descriptions for a complete written description of the structure and operation of such components. To facilitate this process, similar or identical reference numbers will be used for like structures in FIGS. 24-27 as used in FIG. 23.

The rear seal 2400 is substantially similar to the rear seal 2300 of FIG. 23. However, the rear seal 2400 of the illustrated example includes a plurality of bulb seals 2400′ that can be used in place of and/or in addition to the support posts 504 (FIG. 5). Additionally, in some examples, the rear seal 2400 of the illustrated example includes a plurality of mounting brackets 2406 (e.g., in place of the rear seal mounting bracket 2306 of FIG. 23). Specifically, each of the example bulb seals 2400′ of the illustrated example includes a mounting bracket 2406′ (e.g., a dedicated mounting bracket, a mounting bracket similar to the mounting brackets 606, etc.) having a first leg 2406a′ and a second leg 2406b′ (e.g., an L-bracket). In some examples, the bulb seals 2400′ can be used in place of the support posts 504. Thus, in some examples, the curtain 502 can be coupled to the bulb seals 2400′.

In the illustrated example of FIG. 24, the rear seal 2400 includes an insert 2402 in respective ones of the bulb seals 2400′. The insert 2402 provides additional support to the compressible core 2302′. In some examples, the insert 2402 is coupled to the compressible core 2302′ via fasteners 2310′. The insert 2402 can be of the same material as the compressible core 2302′. However, in some examples, the insert 2402 is a made of vinyl, rubber, plastic, etc., and/or has greater stiffness than a stiffness of the material of the compressible core 2302′. The insert 2402 is flexible and compressible when subject to forces (e.g., lowering forces from the dock leveler 10). Thus, the insert 2402 enables the bulb seals 2400′ to retain original form when the dock leveler 10 is raised. Furthermore, the insert 2402 helps provide a stronger seal when the dock leveler 10 is in a lowered position (e.g., the cross-traffic position 1900 of FIG. 19).

In the illustrated examples of FIGS. 25-27, the bulb seal 2400′ includes a cover fastener 2502 to couple the cover 2304 to an underside 2504 of the second leg 2406b′ of the mounting bracket 2406′. In some examples, the cover fastener 2502 is a first member of a hook and loop fastener. The mounting bracket 2406′ can include a second member of the hook and loop fastener positioned on the underside 2504 of the second leg 2406b′. Thus, the second end 2304b of the cover 2304 can couple to the mounting bracket 2406′ via the cover fastener 2502. In some examples, the cover fastener 2502 is a first member of another fastener, such as a snap, buckle, adhesive, etc.

In the illustrated examples of FIGS. 25-27, the bulb seal 2400′ includes a core fastener 2602 to couple the compressible core 2302 to a frontside 2604 of the first leg 2406a′ of the mounting bracket 2406′. In some examples, the core fastener 2602 is a first member of a hook and loop fastener, similar to the cover fastener 2502. The first end 2302a of the compressible core 2302 can include a second member of the hook and loop fastener adjacent to the frontside 2604 of the first leg 2406a′. Thus, the first end 2302a of the compressible core 2302 can couple to the mounting bracket 2406′ via the core fastener 2602. In some examples, the core fastener 2602 is a first member of another fastener, such as a snap, buckle, adhesive, etc.

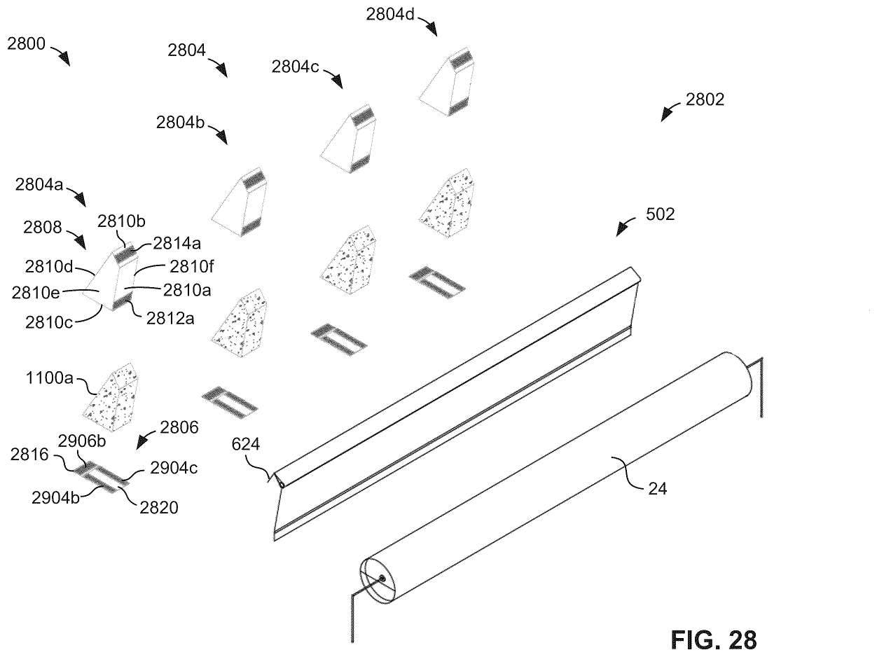

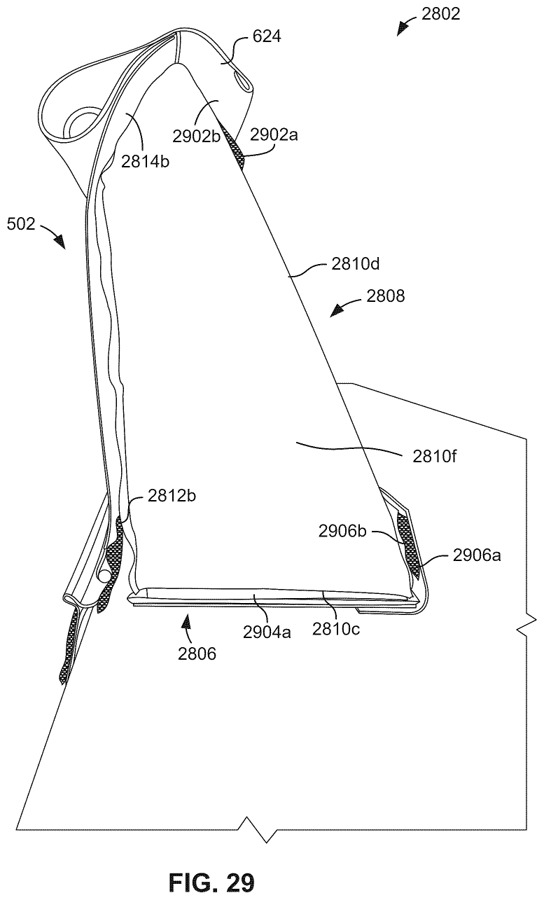

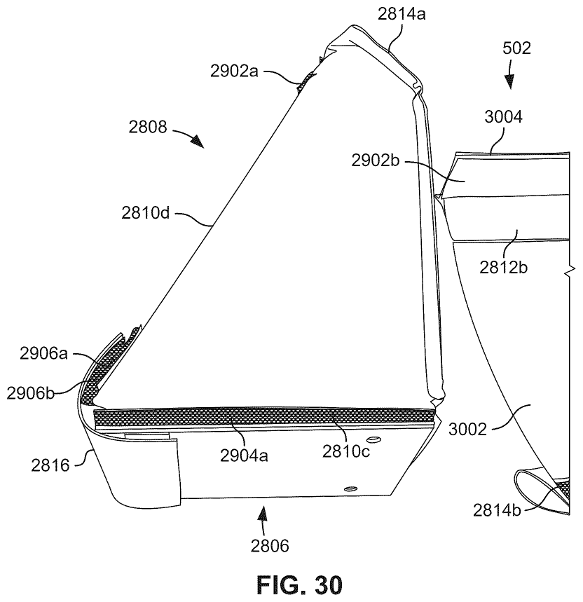

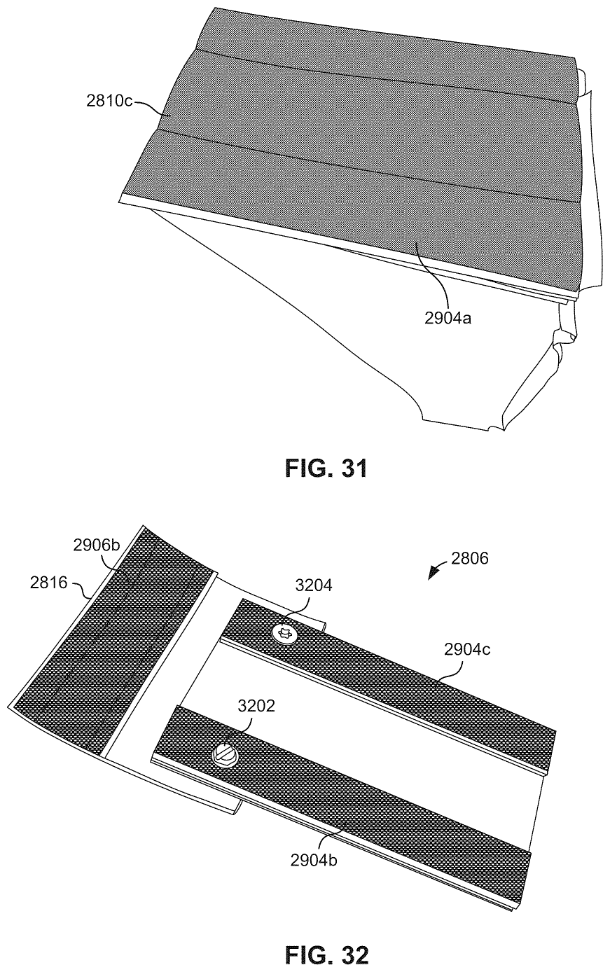

FIG. 28 is an exploded view of another example seal assembly 2800 having another rear seal 2802 disclosed herein. In some examples, the rear seal 2802 can implement the example seal assembly 21 of FIGS. 2-5. FIG. 29 is a side view of the example rear seal 2802 of FIG. 28. FIG. 30 is a perspective, bottom view of an example first support post 2804a of the rear seal 2802 of FIGS. 28 and 29. FIG. 31 is another perspective, bottom view of the example first support post 2804a of FIGS. 28-30. FIG. 32 is a perspective view of an example mounting bracket 2806 of the rear seal 2802 of FIGS. 28 and 29. Many of the components of the example rear seal 2802 of FIGS. 29-32 are substantially similar or identical to the components described above in connection with the rear seal 26 of FIGS. 2-5. As such, those components will not be described in detail again below. Instead, the interested reader is referred to the above corresponding descriptions for a complete written description of the structure and operation of such components. To facilitate this process, similar or identical reference numbers will be used for like structures in FIGS. 28-32 as used in FIGS. 2-5. For the figures disclosed herein, identical numerals indicate the same elements throughout the figures.

In the illustrated example of FIG. 28, the rear seal 2802 includes support posts 2804 to hold or support a curtain 502 upright and spread across a width W (FIG. 5) of a loading dock 12 (FIG. 5). The support posts 2804 of the illustrated example include the first support post 2804a, a second support post 2804b, a third support post 2804c, and a fourth support post 2804d. The support posts 504 of are substantially similar to each other. As such, descriptions of the first support post 2804a likewise applies to the other support posts 2804b-2804d. Furthermore, although four of the support posts 2804 are shown in the illustrated example, the rear seal 2802 can include more than four of the support posts 2804 (e.g., six, eight, etc.) or less than four of the support posts 2804 (e.g., three, two, etc.). In some examples, the rear seal 2802 includes a single one of the support posts 2804 (e.g., positioned adjacent a midpoint of a width in the x-direction (FIG. 5)) and ends of the curtain 502 couple to the respective first and second bumpers 42, 43 or other structure(s) of the loading dock 12 of FIGS. 2-5.

The first support post 2804a of FIG. 28 includes a cover 2808, an example first core 1100a, and an example mounting bracket 2806. In some examples, instead of the first core 1100a, the support posts 2804 can include the core 604 of FIGS. 6 and 9, the core 1000 of FIG. 10, the second core 1100b of FIG. 11B, any combination thereof, and/or any other core. In some examples, the first core 1100a is a foam core or body that is compressible and/or resilient. As such, the first core 1100a can deform in response to compressive forces during impact and restore to an original shape or initial position when the forces (e.g., the impact) are removed. For example, the first core 1100a can include one or more material, such as polyurethane foam, high density foam, lux foam, and/or any other compressible solid. Thus, descriptions of the core 604 of FIG. 6 can likewise apply to the example first core 1100a of FIG. 28.

In some examples, the cover 2808 is substantially similar to the cover 602 of FIG. 6. For example, the cover 2808 can be a fabric and/or leather sheath that can conform to (e.g., form a shape complementary to) a shape of the first core 1100a. Thus, the first support post 2804a includes the cover 2808 to protect and/or contain the first core 1100a. In the illustrated example of FIG. 28, the cover 2808 encases or completely surrounds the first core 1100a. Thus, the cover 2808 includes a first or front surface 2810a (e.g., fore side), a second or upper surface 2810b (e.g., top side), a third or bottom surface 2810c (e.g., under side), a fourth or rear surface 2810d (e.g., aft side), a fifth or left-side surface 2810e and a sixth or right-side surface 2810f that overlay corresponding surfaces of the first core 1100a.

As illustrated in the example of FIG. 28, the cover 2808 includes a first cover fastener 2812a and a second cover fastener 2814a to couple the curtain 502 to the first support post 2804a. Additionally, as illustrated in the example of FIG. 29, the cover 2808 includes a third cover fastener 2902a to couple a header 624 of the curtain 502 to the first support post 2804a. As illustrated in FIG. 29, the curtain 502 includes a first curtain fastener 2812b to couple to the first cover fastener 2812a, a second curtain fastener 2814b to couple to the second cover fastener 2814a, and a third curtain fastener 2902b to couple to the third cover fastener 2902a.

As illustrated in the examples of FIGS. 28 and 29, the first cover fastener 2812a is positioned on the front surface 2810a of the cover 2808, the second cover fastener 2814a is positioned on the upper surface 2810b, and the third cover fastener 2902a is positioned on the rear surface 2810d.

As illustrated in FIG. 30, the first curtain fastener 2812b and the second curtain fastener 2814b are positioned on a rear surface 3002 of the curtain 502. Furthermore, the example third curtain fastener 2902b is positioned on the header 624 (FIG. 28) of the curtain 502. Example positions of the first, second, and third cover fasteners 2812a, 2814a, 2902a align with (e.g., are adjacent to) corresponding ones of the first, second, and third curtain fasteners 2812b, 2814b, 2902b when the curtain 502 extends along the width W of the loading dock 12 and a height of the pit 28 (e.g., a distance between the pit floor 19 and the platform 22 of FIG. 4).

As illustrated in the example of FIGS. 29-31, the cover 2808 includes a first base fastener 2904a and a second base fastener 2906a to couple the first support post 2804a to the mounting bracket 2806. The first base fastener 2904a is positioned on the bottom surface 2810c of the cover 2808. Additionally, the mounting bracket 2806 includes a first mounting fastener 2904b and a second mounting fastener 2904c to couple to the first base fastener 2904a of the cover 2808. In some examples, the mounting bracket 2806 includes a single fastener in place of the first and second mounting fasteners 2904b, 2904c. Furthermore, the mounting bracket 2806 includes a third mounting fastener 2906b on an example tab 2816 to couple to the second base fastener 2906a of the cover 2808. Thus, the tab 2816 and the third mounting fastener 2906b couple or cause the first support post 2804a to remain coupled to the mounting bracket 2806 when the dock leveler 10 is in the lowered position (e.g., the cross-traffic position 1900 of FIG. 19, the below-dock position 2000 of FIG. 20, etc.).

The example fasteners 2812a, 2812b, 2814a, 2814b, 2902a, 2902b, 2904a, 2904b, 2904c, 2906a, and/or 2906b can be implemented as hooks, snaps, magnets, VELCRO pads, hook-and-loop fasteners, and/or any combination thereof. Thus, the first support post 2804a can be removed and/or recoupled to the mounting bracket 2806, and the curtain 502 can be removed and/or recoupled to the first support post 2804a relatively easily by hand without the need for tools or other apparatus.

In some examples, the mounting bracket 2806 can implement the fasteners 510 of FIGS. 5 and 6. Thus, the mounting bracket 2806 couples the first support post 2804a to the loading dock 12. More specifically, the mounting bracket 2806 couples the first support post 2804a to the pit floor 19 of the loading dock 12. The mounting bracket 2806 of the illustrated example includes a base 2820 to carry the first mounting fastener 2904b, the second mounting fastener 2904c, and the tab 2816. For example, the base 2820 is a rectangular metallic (e.g., aluminum, steel, etc.) plate having relatively flat surfaces on which the first mounting fastener 2904b, the second mounting fastener 2904c, and the tab 2816 are affixed via adhesives, hook-and-loop fasteners, snaps, bolts, clamps, etc.

The example mounting bracket 2806 of FIG. 28 is a rectangular bracket rather than an L-shaped bracket (e.g., like the example mounting bracket 606 of FIG. 6) and does not include an arm (e.g., the second arm 614). Thus, the mounting bracket 2806 of the illustrated example couples to the pit floor 19 of the loading dock 12 but not the dock face 40. Thus, the lip 16 can clear the mounting bracket 2806 when the dock leveler 10 is in a lowered position, such as the cross-traffic position 1900 of FIG. 19. In other words, the lip 16 of the dock leveler 10 can sit within the lip keepers (e.g., the lip keepers 48 of FIGS. 3 and 18, the lip keepers 50 of FIGS. 12, 19, 20, etc.) of the loading dock 12 without interaction and/or interference from the mounting bracket 2806. Thus, the rear seal 2802 includes the mounting bracket 2806 to reduce wear of the lip 16 and/or the lip keepers 48, 50.

In the illustrated example of FIG. 32, the mounting bracket 2806 includes a first anchor 3202 and a second anchor 3204 to couple the mounting bracket to (e.g., a floor of) the loading dock 12. As mentioned above, the mounting bracket 2806 does not include an arm to couple to the dock face 40 of the loading dock 12. Thus, the mounting bracket 2806 of the illustrated example includes the first and second anchors 3202, 3204 to facilitate a coupling between the first support post 2804a and (e.g., a floor or ground surface of) the loading dock 12. In some examples, the first and second anchors 3202, 3204 can be decoupled using a tool or another implement (e.g., screwdriver, wrench, drill, etc.). In other words, the mounting bracket 2806 includes the first and second anchors 3202, 3204 to help ensure that the first support post 2804a does not move (e.g., slide, translate, etc.) due to engagement with the dock leveler 10.

The first and second anchors 3202, 3204 of the illustrated example are concrete screws (e.g., Tapcon® concrete screws, etc.). More specifically, the example first anchor 3202 is a hex washer head concrete screw, and the second anchor 3204 is a star flat head concrete screw. However, the first anchor 3202 and/or second anchor 3204 can be any type of fastener compatible with a material composition of the loading dock 12 (e.g., concrete, metal, etc.). In some examples, the mounting bracket 2806 includes one or more resealable fasteners to complement the first and second anchors 3202, 3204. For example, the mounting bracket 2806 can include one or more magnetic fasteners (e.g., the first magnetic fastener 616 of FIG. 6, etc.) to help maintain the position of the mounting bracket 2806 while the first and second anchors 3202, 3204 are installed into the loading dock 12.

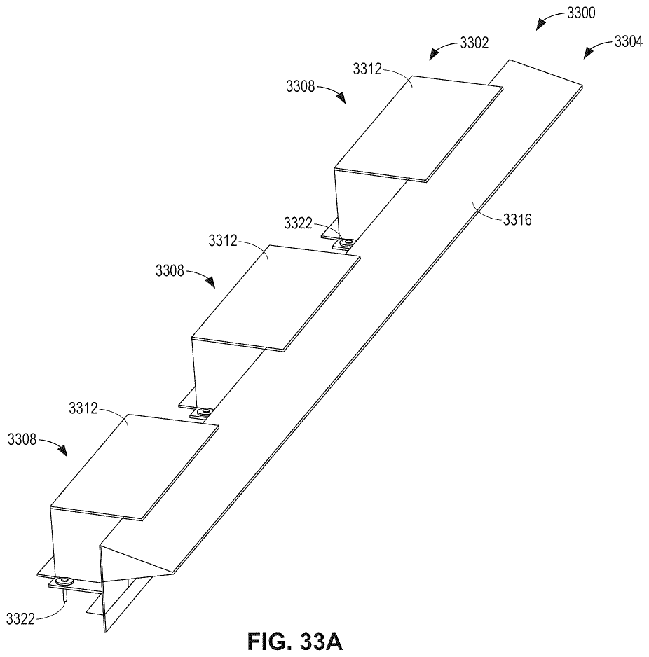

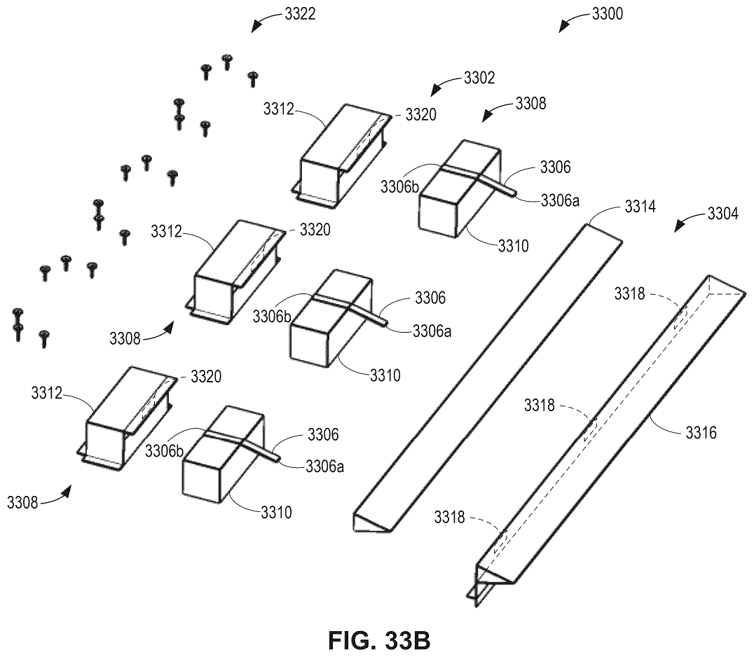

FIG. 33A is a perspective view of another example seal assembly 3300 (e.g., a seal) disclosed herein. FIG. 33B is a perspective, exploded view of the example seal assembly 3300 of FIG. 33A. Referring to FIGS. 33A and 33B, the seal assembly 3300 of the illustrated example includes a first portion or rear seal 3302 (e.g., a first seal) and a second portion or front seal 3304 (e.g., a second seal). The front seal 3304 is pivotally or movably coupled to the rear seal 3302. In other words, the front seal 3304 can move or pivot relative to the rear seal 3304. To pivotally couple the front seal 3304 and the rear seal 3302, the seal assembly 3300 of the illustrated example includes a plurality of stays 3306. Specifically, the front seal 3304 is coupled to the rear seal 3302 via the stays 3306. Thus, the front seal 3304 is pivotally or movably coupled to the rear seal 3302 via the stays 3306.

The rear seal 3302 of the illustrated example includes a plurality of posts 3308. Each of the posts 3308 includes a first or compressible core 3310 and a post cover 3312. The posts 3308 of the illustrated example include the first post 3308a, a second post 3308b, and a third post 3308c. The posts 3308a-c are identical. As such, descriptions of the first post 3308a likewise applies to the other posts 3308. Furthermore, although three of the posts 3308 are shown in the illustrated example, the rear seal 3302 can include more than three of the posts 3308 (e.g., six, eight, etc.) or less than three of the posts 3308 (e.g., one, two, etc.). The front seal 3304 of the illustrated example includes a second compressible core or wedge 3314 and a seal or front cover 3316. In some examples, the compressible core 3310 of the example rear seal 3302 and the wedge 3314 of the front seal 3304 can be a foam core or body that is compressible and/or resilient. For example, the compressible core 3310 of the example rear seal 3302 and the wedge 3314 of the front seal 3304 can include one or more materials, such as polyurethane foam, high density foam, lux foam, and/or any other compressible solid or foam. In some examples, the post cover 3312 of the rear seal 3302 and/or the front cover 3316 of the front seal 3304 can be fabric and/or leather (e.g., a sheath) that can conform to (e.g., form a shape complementary to) a shape of the compressible core 3310 and/or the wedge 3314, respectively.

The stays 3306 of the illustrated example include a first end 3306a and a second end 3306b opposite the first end 3306a. The first end 3306a of each of the stays 3306 couples to the front seal 3304 and the second end 3306b of the stays 3306 couple to the rear seal 3302. Thus, the second end 3306b of the stays 3306 couples to respective ones of the posts 3308. The front seal 304 includes a plurality of first pockets 3318 and the rear seal 3302 includes a plurality of second pockets 3320. The first ends 3306a of the stays 3306 are to be positioned in respective ones of the first pockets 3318 of the front seal 3304 and the second ends 3306b of the stays 3306 to be positioned in respective ones of the second pockets 3320 of the rear seal 3302. In some examples, the stays 3306 can couple to the front seal 3304 and the rear seal 3302 via mechanical fasteners (e.g., bolts, screws), chemical fasteners (e.g., adhesive) and/or any other fastener(s). The stays 3306 of the illustrated example are flexible and provide a spring bias. Therefore, the stays 3306 provide biasing elements that provide a spring-like effect that return to their original or initial position after being deflected. For example, the stays 3306 of the illustrated example can deflect (e.g., downwardly) when an external force (e.g., a downward force of the dock leveler) is imparted to the stays 3306 and return to their initial position when the external force is removed. The stays 3306 can be fiberglass, metal, and/or any other suitable material(s). Thus, the stays 3306 pivotally couple the front seal 3304 and the rear seal 3302. The seal assembly 3300 of the illustrated example includes a first portion (e.g., the front seal 3304) that is pivotally or movably coupled to a second portion (e.g., the rear seal 3302) of the seal assembly 3300. A plurality of fasteners 3322 couple the seal assembly to a loading dock (e.g., the loading dock 12 of FIG. 1).

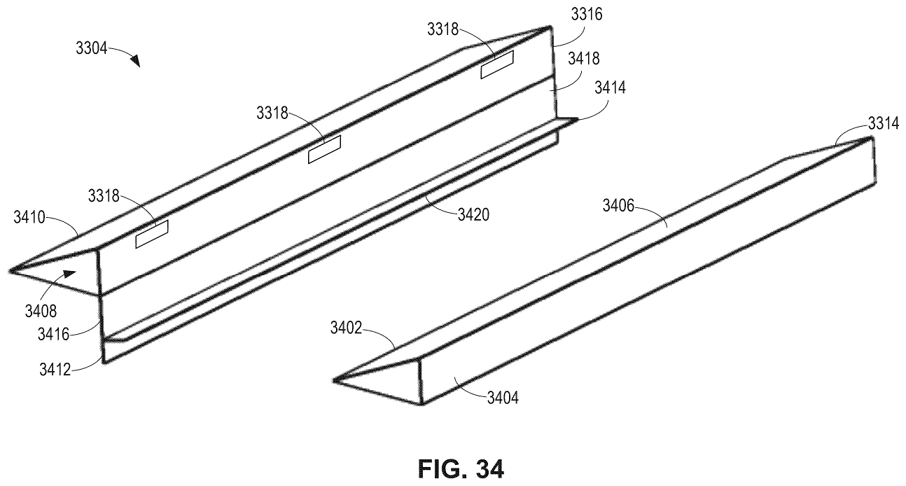

FIG. 34 is an exploded, perspective rear view of the example front seal 3304 of FIGS. 33A and 33B. The front seal 3304 of the illustrated example includes the wedge 3314 (e.g., a compressible core, a foam wedge, etc.) and the front cover 3316. The wedge 3314 of the illustrated example has a triangular shape. Specifically, the wedge 3314 of the illustrated example has a leading edge 3402 (e.g., a front edge) to engage a vehicle and a rear edge 3404 opposite the leading edge 3402 oriented towards and/or to engage the rear seal 3302. The wedge 3314 of the illustrated example has a slope or angled surface 3406 extending between the rear edge 3404 and the leading edge 3402. The wedge 3314 of the illustrated example is a unitary or one-piece structure. The wedge 3314 of the illustrated example is a compressible core or foam wedge that compresses and/or otherwise provides a seal (e.g., when engaged by a vehicle). In some examples, the wedge 3314 can have a square shape (e.g., a square cross-sectional shape), a rectangular shape (e.g., a rectangular cross-sectional shape), a circular shape (e.g., a circular cross-sectional shape) and/or any other shape(s).

The front cover 3316 of the illustrated example encases or wraps (e.g., completely surrounds) around the wedge 3314. Thus, the front cover 3316 has a cavity 3408 to receive the wedge 3314. Specifically, the front cover 3316 of the illustrated example includes a wedge cover 3410 having the cavity 3408 to receive the wedge 3314. Additionally, the front cover 3316 of the illustrated example includes a curtain 3412 extending from the wedge cover 3410 and a mounting flange 3414 extending from the curtain 3412. The wedge cover 3410 extends away from a first or front side 3416 of the curtain 3412 and the mounting flange 3414 extends away from a second or rear side 3418 of the curtain 3412 opposite the front side 3416. The mounting flange 3414 of the illustrated example is a flap 3420 (e.g., a flap of material). The flap 3420 is engaged by the rear seal 3302 to couple the front seal 3304 to a loading dock. Specifically, the flap 3420 of the front cover 3316 is positioned underneath the posts 3308 to couple the front seal 3304 to the loading dock. The front cover 3316 and/or the wedge cover 3410 of the front cover 3316 includes the pockets 3318 to allow at least a portion of the stays 3306 to pass through the front cover 3316 and couple to the wedge 3314.

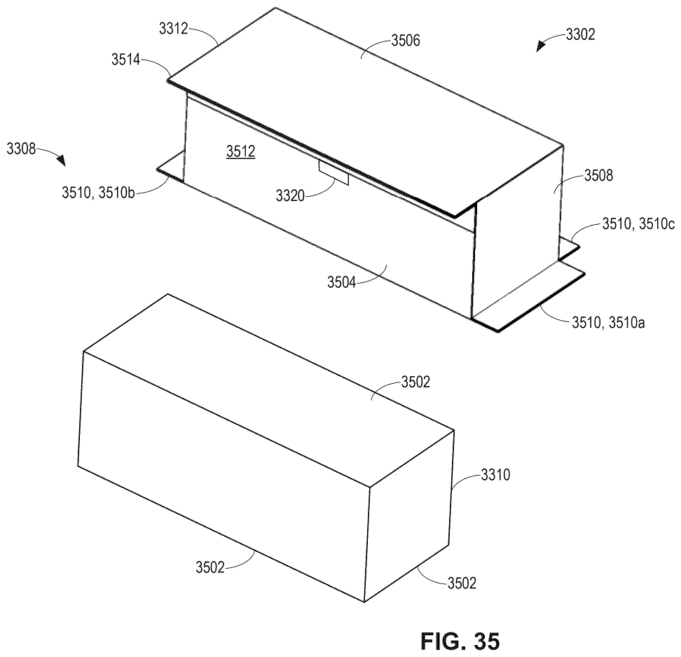

FIG. 35 is a perspective, exploded view of an example post 3308 of the example rear seal 3302 of FIGS. 33A and 33B. The post 3308 of the illustrated example each includes the compressible core 3310 (e.g., a foam block) and the post cover 3312. The compressible core 3310 of the illustrated example is a compressible foam block (e.g., a rectangular shaped block). The post cover 3312 wraps or encases the compressible core 3310. Specifically, the post cover 3312 overlaps or covers corresponding surfaces 3502 of the compressible core 3310. For example, the post cover 3312 includes a first or front surface 3504 (e.g., fore side), a second or rear surface (e.g., aft side) opposite the front surface 3504, a third or upper surface 3506 (e.g., a top surface), a fourth or right-side surface 3508 and a fifth or left-side surface opposite the right-side surface that overlay the corresponding surfaces 3502 of the compressible core 3310. Thus, the post cover 3312 of the illustrated example defines a cavity to receive the compressible core 3310. To mount the rear seal 3302 to the pit floor 19, the post cover 3312 of the illustrated example includes a plurality of mounting flanges or mounting flaps 3510. Specifically, the post cover 3312 includes a first side mounting flap 3510a, a second side mounting flap 3510b and a rear mounting flap 3510c. The mounting flaps 3510 project outwardly or away from a core or central body 3512 of the post cover 3312 (e.g., that covers the compressible core 3310). The post cover 3312 of the illustrated example also includes an overlap flap 3514 that at least partially overlaps the front seal 3304 when the front seal 3304 is coupled to the rear seal 3302. In some examples, the overlap flap 3514 covers (e.g., protects) exposed portions of the stays 3306. The overlap flap 3514 projects or protrudes away from the front surface 3504 of the post cover 3312 opposite the rear side having the rear mounting flap 3510c. The front surface 3504 of the post cover 3312 engages or receives (e.g., the rear side 3404, 3418 of) the front seal 3304. Additionally, the front surface 3504 of the post cover 3312 has the pocket 3320 (e.g., an opening) to allow at least a portion of the stay 3306 associated with the post 3308 to pass through the post cover 3312. The compressible core 3310 of the post 3308 of the illustrated example has a rectangular shape or profile. However, in other examples, the compressible core 3310 can have a square shape, a cylindrical shape, a circular shape, and/or any other suitable shape.

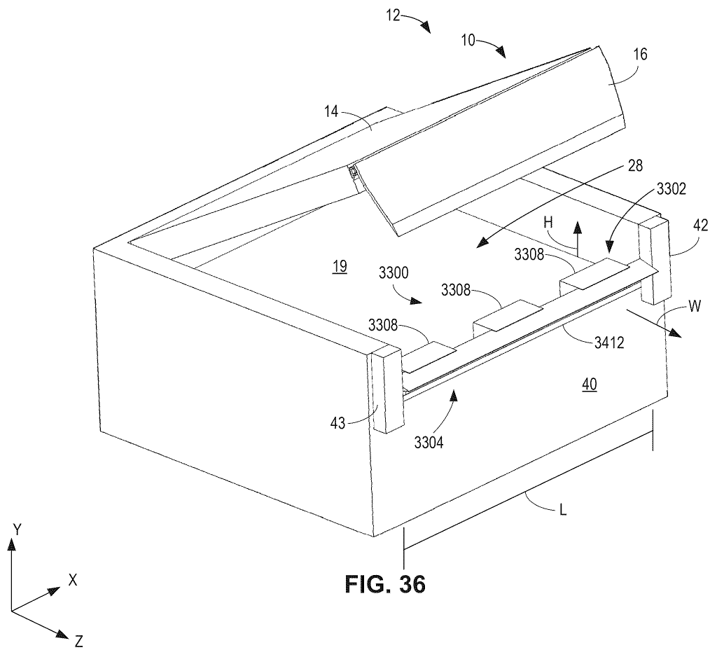

FIG. 36 is a perspective view of the example loading dock 12 and the dock leveler 10 of FIG. 1 including the example seal assembly 3300 of FIGS. 33A and 33B. The seal assembly 3300 of the illustrated example is a seal that couples to the pit floor 19 of the pit 28 of the loading dock 12 that is configured to receive the dock leveler 10 of the loading dock 12. The seal assembly 3300 of the illustrated example attaches to the pit floor 19 adjacent to a front edge of the pit floor 19.

The seal assembly 3300 spans between the first bumper 42 and the second bumper 43 and/or between the side walls 28a of the pit 28. Additionally, the seal assembly 3300 projects away from the dock face 40 to engage the rear edge 66 (or surface) of the trailer or vehicle 20 when the vehicle is in engagement with the first bumper 42 and the second bumper 43. In other words, in the illustrated example, the seal assembly 3300 is cantilevered from the pit floor 19. In this manner, the seal assembly 3300 projects a distance Z away from the dock face 40 of the loading dock 12. Additionally, the seal assembly 3300 spans a distance H from the pit floor 19 (e.g., in the vertical or y-direction). Thus, the seal assembly 3300 of the illustrated example projects or spans a first distance L to seal a gap in the x-direction, a second distance H to seal a gap in the y-direction, and a third distance W to seal a gap in the z-direction. Specifically, the rear seal 3302 spans between the first bumper 42 and the second bumper 43 and extends away from the pit floor 19, and the front seal 3304 spans between the first bumper 42 and the second bumper 43 and projects away from the dock face 40. The seal assembly 3300 of the illustrated example seals against or engages the rear edge 66 of the vehicle 20 when the vehicle 20 is parked at the loading dock 12. In some examples, the front seal 3304 and/or the rear seal 3302 engage the rear edge 66 of the vehicle 20 such that at least a portion of the front seal 3304 and/or the rear seal 3302 engage at least a portion of a surface of the vehicle 20 adjacent to the rear edge 66 that is oriented toward the dock face 40 and/or a portion of a surface of the vehicle 20 adjacent the rear edge 66 that is oriented toward the driveway 37.

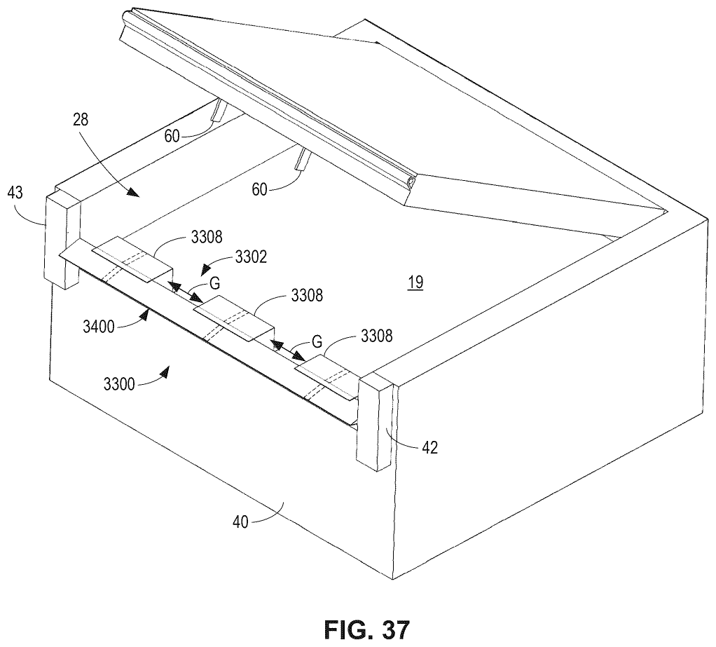

FIG. 37 is a perspective view of FIG. 36 with the lip 16 of the dock leveler 10 removed. The wedge 3314 of the front seal 3304 has a longitudinal length L to fit between the side walls 28a of the pit 28. The posts 3308 are spaced apart between the side walls 28a of the pit 28. Specifically, the posts 3308 of the rear seal 3302 are positioned between the stump out legs 60 of the deck 14 of the dock leveler 10. In other words, a gap G is provided between respective ones of the posts 3308. The gaps G align with respective ones of the stump out legs 60. During operation of the dock leveler 10, the gaps G receive respective ones of the stump out legs 60. Thus, the seal assembly 3300 of the illustrated example does not interfere with the stump out legs 60 of the deck 14 of the dock leveler 10 during operation. Likewise, the stump out legs 60 do not interfere with or damage the seal assembly 3300. The curtain 3412 of the front seal 3304 covers or blocks the gaps G from the dock face 40 side of the loading dock 12. Thus, the curtain 3412 provides an obstruction or seal that prevents or restricts airflow, debris, or other particulate from flowing or passing through the gaps G of the rear seal 3302 from a front side (e.g., the dock face 40 side) of the loading dock 12.

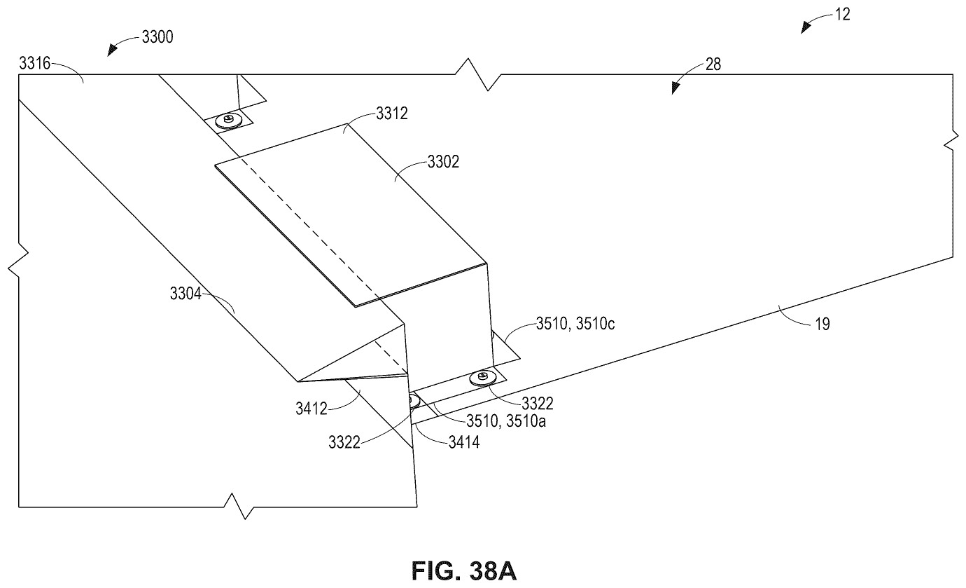

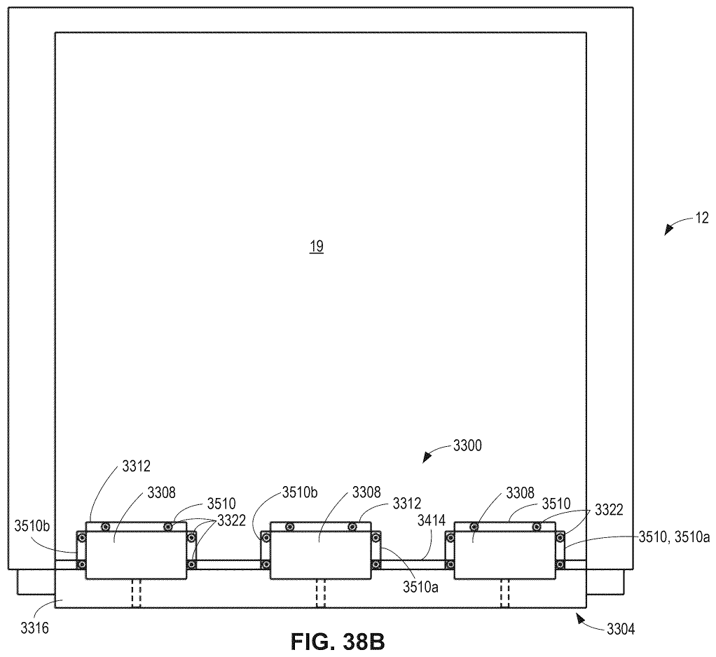

FIG. 38A is an enlarged, partial, perspective view of the loading dock 12 of FIG. 36. FIG. 38B is a top view of the dock leveler of FIG. 38A. The seal assembly 3300 of the illustrated example couples to the pit floor 19 of the pit 28. In particular, the rear seal 3302 couples the front seal 3304 to the pit floor 19. For example, the mounting flange 3414 of the front cover 3316 and the mounting flaps 3510 of the post covers 3312 receive one or more of the fasteners 3322 to couple the seal assembly 3300 to the pit floor 19. Specifically, the mounting flange 3414 of the front cover 3316 is positioned underneath at least a portion of the side mounting flaps 3510a, 3510b of the post covers 3312 and/or the posts 3308. The fasteners 3322 pass through the side mounting flaps 3510a, 3510b and the rear mounting flaps 3510c of the post covers 3312 and the mounting flange 3414 of the front cover 3316 and into the pit floor 19 to secure the seal assembly 3300 to the pit floor 19. Additionally, the mounting flange 3414 of the front cover 3316 is positioned underneath a portion of the compressible core 3310 of the posts 3308. In some examples, the curtain 3412 of the front cover 3316 can be coupled to the dock face 40 via one or more fasteners, adhesive, hook-and-loop fasteners, brackets, magnets, and/or any other suitable fasteners. In some examples, the seal assembly 3300 includes a plate or backer (e.g., a metal plate, a wood backer) positioned between the posts 3308 and the pit floor 19.

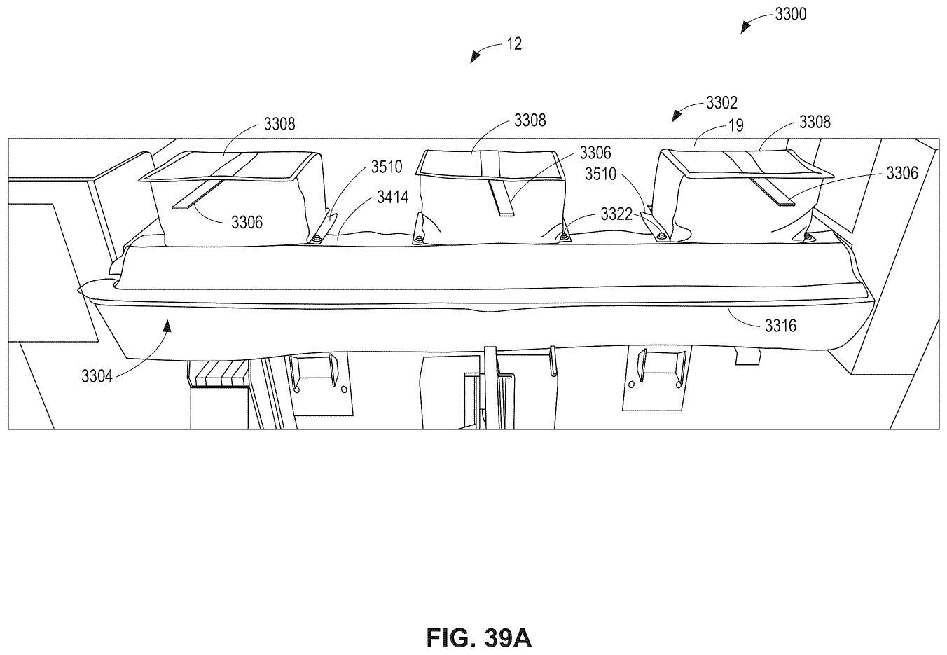

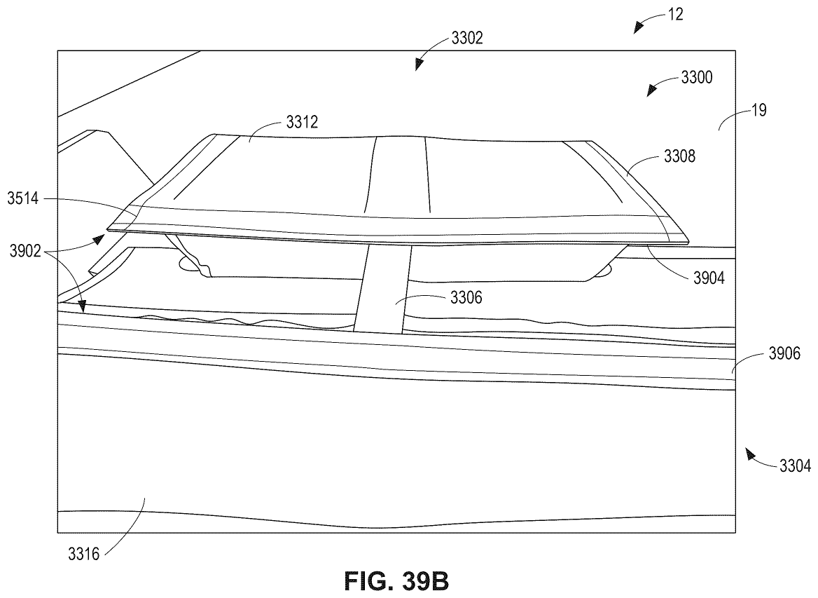

FIG. 39A is a front view of the loading dock 12 with the example seal assembly 3300 in a partially assembled state. As shown in FIG. 39A, the mounting flange 3414 of the front cover 3316 of the front seal 3304 and the mounting flaps 3510 of the post covers 308 of the rear seal 3302 is coupled to the pit floor 19 via the fasteners 3322. However, the front seal 3304 is decoupled from the stays 3306. In FIG. 39A, the second end 3306b of the stays 3306 are coupled or attached to respective ones of the compressible core 3310 of the posts 3308 and the first end 3306a of the stays 3306 project or protrude from the posts 3308 via the pockets 3320 of the post covers 3312.

FIG. 39B is an enlarged, partial view of the seal assembly 3300 showing the front seal 3304 partially coupled to the stay 3306 of the rear seal 3302. Specifically, the first end 3306a of the stay 3306 is positioned within the pocket 3318 of the front cover 3316. In some examples, the post covers 3312 and/or the front cover 3316 can include one or more pockets to receive the stays 3306. Thus, respective first ends 3306a of the stays 3306 are attached to the wedge 3314 of the front seal 3304 and respective second ends 3306b of the stays 3306 are attached to respective ones of the compressible cores 3310 of the rear seal 3302. Additionally, the seal assembly 3300 of the illustrated example includes a fastener 3902 (e.g., a hook-and-loop fastener) to couple the front seal 3304 and the rear seal 3302. Specifically, the post cover 3312 (e.g., an underside of the overlap flap 3514) includes a first portion 3904 (e.g., one of a hook or loop portion of a hook-and-loop fastener) and the front cover 3316 includes a second portion 3906 (e.g., the other one of the hook or loop portion of the hook-and-loop fastener). When the stays 3306 are positioned in the respective pockets 3318 of the front cover 3316 and the pockets 3320 of the post covers 3312, the overlap flap 3514 engages the front cover 3316 to couple via the fastener 3902.

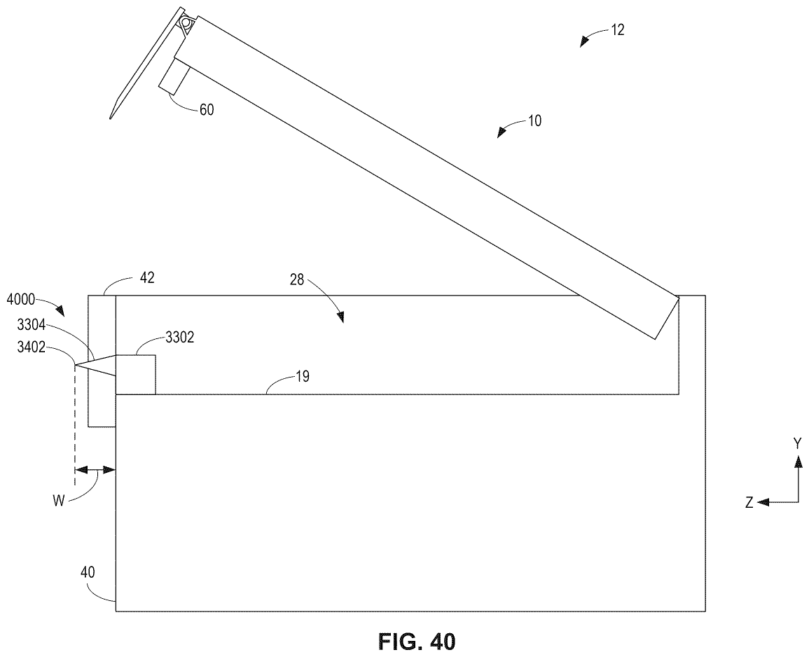

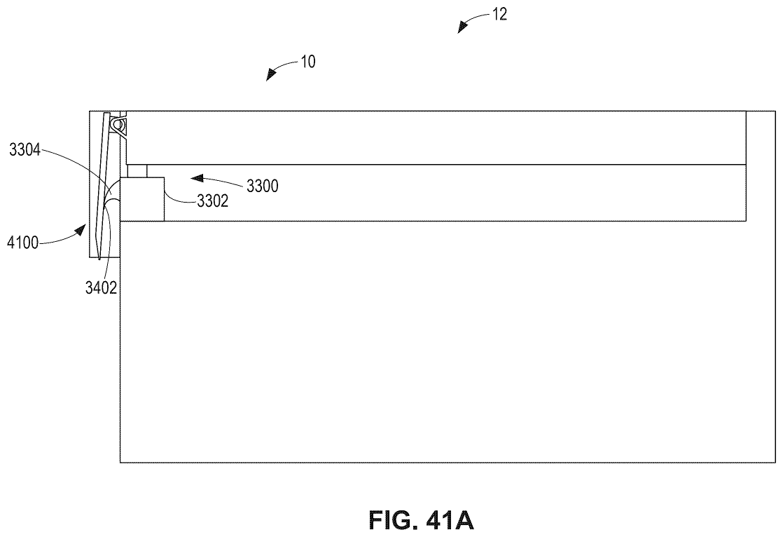

FIG. 40 is a side view of the example loading dock 12 with the example dock leveler 10 in an example stored position 500 (e.g., a vertical position). When the dock leveler 10 is not engaged with the seal assembly 3300, the seal assembly 3300 is in an example first or initial position 4000. In the initial position 4000, the front seal 3304 protrudes from the dock face 40 of the loading dock 12. Specifically, the front seal 3304 protrudes the distance W away from a front surface 4402 of the bumpers 42, 43. In other words, the front seal 3304 and/or the leading edge 3402 of the front seal 3304 is cantilevered from the pit floor 19. Thus, the leading edge 3402 of the front seal 3304 protrudes away from the rear seal 3302 when the front seal 3304 is in the initial position 4000. The front seal 3304 is cantilevered from the rear seal 3302. The stays 3306 of the illustrated example bias or move the front seal 3304 toward the initial position 4000. In the initial position 4000, the wedge 3314 of the front seal 3304 (and/or the compressible core 3310 of the rear seal 3302) can deform in response to compressive forces from the vehicle 20 during impact and restore to an original shape or initial position when the forces (e.g., the impact) from the vehicle 20 are removed.

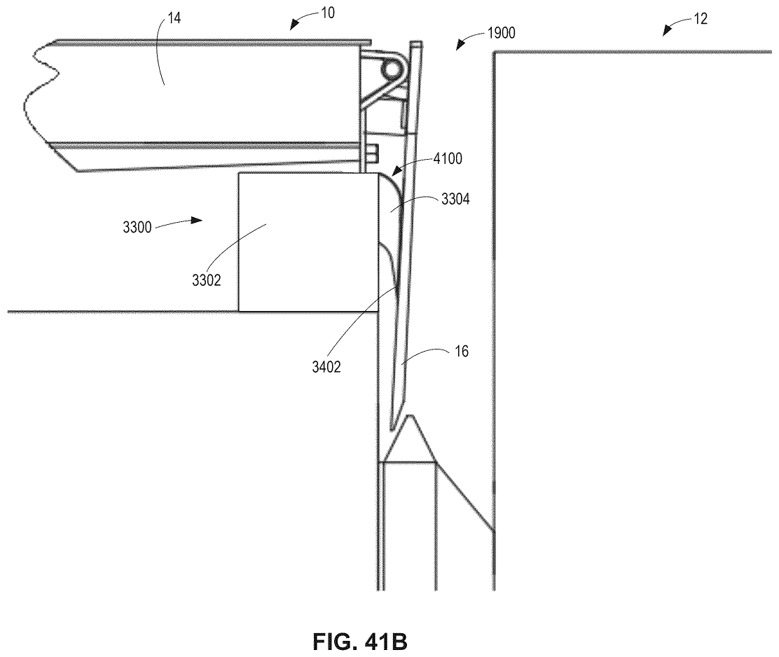

FIG. 41A is a side view of the example loading dock 12 with the dock leveler 10 rotating toward the example cross-traffic position 1900 of FIG. 19 and the example seal assembly 3300 in an example first deflected position 4100. When the deck 14 and/or the lip 16 of the dock leveler 10 engages the front seal 3304, the front seal 3304 can compress, bend, rotate and/or pivot relative to the rear seal 3302 and/or the dock face 40. The stays 3306 bend or deflect (e.g., downward in the orientation of FIG. 41A) to enable the front seal 3304 to pivot relative to the rear seal 3302 between the initial position 4000 at which the front seal 3304 projects from the rear seal 3302 (e.g., in the z-direction) and the example first deflected position 4100 at which the front seal 3304 pivots, bends, compresses, and/or deflects downward and/or moves toward the rear seal 3302. Specifically, the angled surface 3406 causes the leading edge 3402 and, thus, the compressible body 3314 to bend, compress, deflect and/or rotate relative to the rear seal 3302. In other words, the leading edge 3402 of the front seal 3304 moves downward (e.g., in the y-direction) and/or toward the rear seal 3302 (e.g., in the x-direction) when the front seal 3304 is in the first deflected position 4100 (e.g., moves in the zy-direction). After the dock leveler 10 disengages from or releases the front seal 3304, the stays 3306 cause the front seal 3304 to pivot or rotate relative to the rear seal 3302 from the first deflected position 4100 toward the initial position 4000.

FIG. 41B is a partial side view of the example loading dock 12 with the dock leveler 10 in the example cross-traffic position 1900 of FIG. 19 and the example seal assembly 3300 in an example second deflected position 4102. In the cross-traffic position 4102 of FIG. 41B, the lip 16 is rotated further toward the dock face 40 compared to the cross-traffic position 4100 of FIG. 41A. When the deck 14 and/or the lip 16 of the dock leveler 10 engages the front seal 3304 (e.g., in the cross-traffic position 1900), the front seal 3304 can further compress, bend, rotate and/or pivot relative to the rear seal 3302 and/or the dock face 40 to an example second deflected position 4102. After the dock leveler 10 disengages from or releases the front seal 3304, the stays 3306 cause the front seal 3304 to pivot or rotate relative to the rear seal 3302 from the second deflected position 4102 toward the initial position 4000.

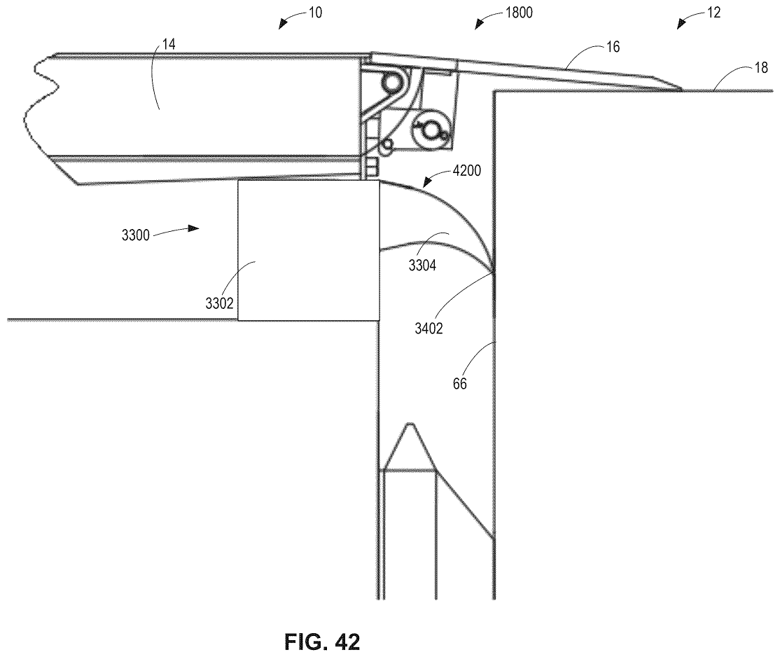

FIG. 42 is a partial side view of the example loading dock 12 with the dock leveler 10 in the standard loading position 1800 (e.g., of FIG. 18) and the example seal assembly 3300 in an example third deflected position 4200. When the deck 14 and/or the lip 16 are in the standard loading position 1800, the vehicle cargo bed 18 engages the front seal 3304. The seal assembly 3300 (e.g., the front seal 3304) seals against the rear edge 66 of the vehicle cargo bed 18. In particular, when the vehicle cargo bed 18 engages the front seal 3304, the front seal 3304 (e.g., the leading edge 3402) compresses, bends, rotates and/or pivots relative to the rear seal 3302 and/or the dock face 40. The stays 3306 bend or deflect (e.g., downward in the orientation of FIG. 42) to enable the front seal 3304 to pivot relative to the rear seal 3302 between the initial position 4000 at which the front seal 3304 projects from the rear seal 3302 (e.g., in the z-direction) and an example third deflected position 4200 at which the front seal 3304 pivots, bends, compresses, and/or deflects downward and/or moves toward the rear seal 3302. In other words, the leading edge 3402 of the front seal 3304 moves downward (e.g., in the y-direction) and/or toward the rear seal 3302 (e.g., in the x-direction) when the front seal 3304 is in the third deflected position 4200. After the dock leveler 10 disengages from or releases the front seal 3304, the stays 3306 cause the front seal 3304 to pivot or rotate relative to the rear seal 3302 from the third deflected position 4200 toward the initial position 4000.

In alternative examples, the front seal 3304 can be pivotally coupled to the loading dock 12 via a hinge. For example, a shaft can couple the front seal 3304 between the respective bumpers 42, 44 and/or the side walls 28a of the pit 28. The shaft can include a spring or other biasing element to bias the front seal 3304 toward the initial position 4000 and allow deflection of the front seal 3304 toward the deflected position 4100. Example biasing elements that can be used to bias the front seal 3304 and/or enable rotation of the front seal 3304 relative to the rear seal 3302 include torsion springs, helical springs, leaf springs, and/or any other suitable biasing element or spring. Example hinges disclosed herein can include the stays 3306, a spring-loaded shaft, a piano hinge, and/or any other suitable hinge(s) for rotatably coupling the front seal 3304 relative to the rear seal 3304.

The foregoing examples of the seal assembly 21, 2800, 3300, the cores 604, 1000, 1100a, 1100b, the front seals 24, 1401, 3304, the rear seals 26, 2300, 2400, 2802, 3304 can implement seals for loading docks. Although each example seal assembly 21, 2800, 3300 the cores 604, 1000, 1100a, 1100b, 3310, the wedge 3314, the front seals 24, 1401, 3304, the rear seals 26, 2300, 2400, 2802, 3304 and/or other components disclosed above have certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, stating that any part is in any way positioned on (e.g., located on, disposed on, formed on, coupled to, etc.) another part, means that the referenced part is either in contact with the other part, or that the referenced part is spaced from the other part with one or more intermediate part(s) located therebetween. Stating that any part is in contact with another part means that there is no intermediate part between the two parts. Connection references (e.g., attached, coupled, connected, joined, detached, decoupled, disconnected, separated, etc.) are to be construed broadly and may include intermediate members between a collection of elements and relative movement between elements unless otherwise indicated. As used herein, the term “decouplable” refers to the capability of two parts to be attached, connected, and/or otherwise joined and then be detached, disconnected, and/or otherwise non-destructively separated from each other (e.g., by removing one or more fasteners, removing a connecting part, etc.). As such, connection/disconnection references do not necessarily infer that two elements are directly connected and in fixed relation to each other.

Descriptors “first,” “second,” “third,” etc., are used herein when identifying multiple elements or components which may be referred to separately. Unless otherwise specified or understood based on their context of use, such descriptors are not intended to impute any meaning of priority, physical order, or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

From the foregoing, it will be appreciated that example methods, apparatus and articles of manufacture have been disclosed that provide one or more benefits including improved sealing between the front edge of a dock leveler pit and a rear edge of a vehicle, regardless of the position of the dock leveler's lip, a vehicle-impactable front seal, a sealing system that provides clear open access to the dock leveler's pit, and/or a sealing system that can be used on a vertical storing deck. Example seal apparatus or seal assembly disclosed herein includes a plurality of posts interspersed between stump out legs of the dock leveler to reduce wear and/or damage incurred to the rear seal and/or the front seal. Example seal apparatus disclosed herein include flexible mounts to support the front seal, improve the sealing capability of the seal apparatus, and reduce wear and/or damage incurred to the seal apparatus, the loading dock, and/or the dock leveler.

Example seals for loading docks are disclosed herein. Further examples and combinations thereof include the following:

Example 1 includes a seal assembly comprising a rear seal including a plurality of posts, a front seal, and a plurality of stays, the stays pivotally couple the front seal and the posts.

Example 2 includes the seal assembly of example 1, wherein the posts include foam blocks.

Example 3 includes the seal assembly of example 1, wherein the front seal includes a foam wedge.

Example 4 includes the seal assembly of example 1, wherein the front seal includes a flap that is positioned underneath the posts.

Example 5 includes the seal assembly of example 1, wherein the front seal includes a plurality of first pockets and the rear seal includes a plurality of second pockets, respective first ends of the stays to be positioned in respective ones of the first pockets of the front seal and respective second ends of the stays to be positioned in respective ones of the second pockets of the rear seal.

Example 6 includes the seal assembly of example 1, wherein respective ones of the posts of the rear seal are to be positioned between stump out legs of a dock leveler.

Example 7 includes a seal assembly comprising a first seal to couple to a pit of a loading dock, a second seal pivotally coupled relative to the first seal, the second seal to move between a first position and a second position, a leading edge of the second seal to protrude away from the first seal when the second seal is in the first position, the leading edge of the second seal to move toward the first seal when the second seal is in the second position.

Example 8 includes the seal assembly of example 7, wherein the first seal includes a plurality of posts, the posts to be spaced apart between side walls of the pit.

Example 9 includes the seal assembly of example 8, wherein the second seal includes a wedge having a longitudinal length to fit between the side walls of the pit.

Example 10 includes the seal assembly of example 7, wherein the second seal includes a rear edge opposite the leading edge, the rear edge of the second seal pivotally coupled to the first seal.

Example 11 includes the seal assembly of example 7, wherein the second seal is cantilevered from the first seal.

Example 12 includes the seal assembly of example 7, wherein the second seal is pivotally coupled to the first seal via a plurality of stays.

Example 13 includes the seal assembly of example 12, wherein the stays each includes a first end coupled to the first seal and a second end coupled to the second seal.

Example 14 includes the seal assembly of example 12, wherein the stays enable the second seal to pivot relative to the first seal between a first position at which the second seal projects from the first seal and a second position at which the second seal moves toward the first seal.

Example 15 includes the seal assembly of example 14, wherein the stays bias the second seal toward the first position.

Example 16 includes the seal assembly of example 7, wherein the second seal includes a foam and a cover, the cover having a flap, the flap to be engaged by the first seal to couple the second seal to a loading dock.

Example 17 includes a seal assembly for a loading dock, the seal assembly comprising a seal to couple to a pit floor of a pit area that is configured to receive a dock leveler of a loading dock, the seal to attach to the pit floor adjacent an edge of the pit floor, the seal to span between a first bumper and a second bumper of the loading dock, the seal to project from a dock face to engage a rear surface of a trailer of a vehicle when the vehicle is in engagement with the first bumper and the second bumper, and the seal to extend away from the pit floor to span a height between the pit floor and the rear surface of the trailer.

Example 18 includes the seal of example 17, wherein a first portion of the seal is cantilevered from the pit floor.

Example 19 includes the seal of example 17, wherein a first portion of the seal is pivotally coupled to a second portion of the seal.

Example 20 includes the seal of example 17, wherein the seal is to project a distance away from a dock face of a loading dock.

The following claims are hereby incorporated into this Detailed Description by this reference. Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A seal assembly comprising:
a rear seal including a plurality of posts;
a front seal; and
a plurality of stays, the stays pivotally couple the front seal and the posts.

2. The seal assembly of claim 1, wherein the posts include foam blocks.

3. The seal assembly of claim 1, wherein the front seal includes a foam wedge.

4. The seal assembly of claim 1, wherein the front seal includes a flap that is positioned underneath the posts.

5. The seal assembly of claim 1, wherein the front seal includes a plurality of first pockets and the rear seal includes a plurality of second pockets, respective first ends of the stays to be positioned in respective ones of the first pockets of the front seal and respective second ends of the stays to be positioned in respective ones of the second pockets of the rear seal.

6. The seal assembly of claim 1, wherein respective ones of the posts of the rear seal are to be positioned between stump out legs of a dock leveler.

7. A seal assembly comprising:
a first seal to couple to a pit of a loading dock;
a second seal pivotally coupled relative to the first seal, the second seal to move between a first position and a second position, a leading edge of the second seal to protrude away from the first seal when the second seal is in the first position, the leading edge of the second seal to move toward the first seal when the second seal is in the second position.

8. The seal assembly of claim 7, wherein the first seal includes a plurality of posts, the posts to be spaced apart between side walls of the pit.

9. The seal assembly of claim 8, wherein the second seal includes a wedge having a longitudinal length to fit between the side walls of the pit.

10. The seal assembly of claim 7, wherein the second seal includes a rear edge opposite the leading edge, the rear edge of the second seal pivotally coupled to the first seal.

11. The seal assembly of claim 7, wherein the second seal is cantilevered from the first seal.

12. The seal assembly of claim 7, wherein the second seal is pivotally coupled to the first seal via a plurality of stays.

13. The seal assembly of claim 12, wherein the stays each includes a first end coupled to the first seal and a second end coupled to the second seal.

14. The seal assembly of claim 12, wherein the stays enable the second seal to pivot relative to the first seal between a first position at which the second seal projects from the first seal and a second position at which the second seal moves toward the first seal.

15. The seal assembly of claim 14, wherein the stays bias the second seal toward the first position.

16. The seal assembly of claim 7, wherein the second seal includes a foam and a cover, the cover having a flap, the flap to be engaged by the first seal to couple the second seal to a loading dock.

17. A seal assembly for a loading dock, the seal assembly comprising:
a seal to couple to a pit floor of a pit area that is configured to receive a dock leveler of a loading dock, the seal to attach to the pit floor adjacent an edge of the pit floor, the seal to span between a first bumper and a second bumper of the loading dock, the seal to project from a dock face to engage a rear surface of a trailer of a vehicle when the vehicle is in engagement with the first bumper and the second bumper, and the seal to extend away from the pit floor to span a height between the pit floor and the rear surface of the trailer.

18. The seal of claim 17, wherein a first portion of the seal is cantilevered from the pit floor.

19. The seal of claim 17, wherein a first portion of the seal is pivotally coupled to a second portion of the seal.

20. The seal of claim 17, wherein the seal is to project a distance away from a dock face of a loading dock.
